(19) United States
(12) Patent Application Publication
(10) Pub. No.: US 2010/0255414 A1
(43) Pub. Date: Oct. 7, 2010

(54) Toner, Process for Making Toner and Use of Toner

(76) Inventors: Daniel Patrick Morris, Manchester (GB); Martin Russell Edwards, Manchester (GB); Mohammed Nawaz, Manchester (GB); Simon Pickard, Cheshire (GB)

Correspondence Address: MORGAN LEWIS & BOCKIUS LLP, 1111 PENNSYLVANIA AVENUE NW, WASHINGTON, DC, 20004, US

(21) Appl. No.: 12/598,220

(22) PCT Filed: Apr. 29, 2008
(86) PCT No.: PCT/GB08/01503

§ 371 Date: Dec. 14, 2009

(30) Foreign Application Priority Data
May 4, 2007 (GB) 0708613.5

(51) Int. Cl. G03G 9/08; G03G 9/12; G03G 9/107; G03G 9/09

(52) U.S. Cl. 430/108.4; 430/137.22

(57) ABSTRACT

A process for the manufacture of a toner comprising toner particles which comprise at least resin and colorant, the process comprising the steps of: providing a mixed dispersion of at least primary resin particles, primary colorant particles and a carboxy functional compound of Formula (1) and/or a salt thereof and/or a complex thereof in a liquid medium,

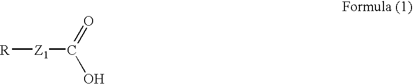

wherein R is a carbocyclic or heterocyclic group and Z₁ is a bond or a linker group,
the at least primary resin particles and primary colorant particles being stabilised by two or more surfactants in the liquid medium, the surfactants comprising at least a first ionic surfactant and a second ionic surfactant of the same polarity as the first ionic surfactant, wherein the first and second ionic surfactants have different linear chain lengths; and causing the primary particles to associate.

### FIELD OF THE INVENTION

The invention relates generally to toner for electrophotographic use, to processes for preparing toner and uses of toner in electrophotography.

### BACKGROUND

Electrophotography encompasses image forming technologies such as, for example, photocopying and laser printing. In these technologies a latent, electrostatic image is produced by forming an electrostatic charge on the surface of a photoconductive component (e.g. a drum) and partially or fully discharging the electrostatic charge on parts of the surface of the photoconductive component by exposing those parts to light. The exposure may be from light reflected from an illuminated image (photocopying) or from a laser which scans the photoconductive component, usually under instruction from a computer (laser printing). Once a latent image has been produced it is developed, using a toner, to form a visible image on the photoconductive component which can then be transferred onto a suitable substrate (e.g. paper). Typically the toner is then fused to the substrate by means of heat and/or pressure. In this way a hard copy of the image is obtained. The toner may be employed without a magnetic carrier as so-called “one-component” developer or the toner may be employed with a magnetic carrier as so-called “two component” developer. During use, friction between particles of toner, with their carrier and/or with parts of the printer device cause the toner particles to obtain an electrostatic charge (tribocharge) which enables them to develop the latent, electrostatic image.

Toner comprises toner particles typically of average particle size 1-50 μm but more usually 2-15 μm. The toner particles typically comprise a binder resin, a colorant and optionally other ingredients such as, for example, wax, lubricant and/or charge control agent to improve the properties of the toner. The resin acts to fix the toner to the substrate, usually by fusion of the resin onto the substrate by heating. The colorant, which is usually a pigment, imparts the required colour to the toner. Toners typically also comprise one or more surface additives mixed with the toner particles to modify properties including flowability and chargeability.

There are many demanding performance requirements of a toner. For instance, a toner desirably possesses as many of the following characteristics as possible: fixability to a substrate at low temperatures (e.g. by means of heated fusion rollers); releasability from fusion rollers over a wide range of fusion temperatures and/or speeds and/or over a wide range of toner print densities; good storage stability; good print transparency; good toner charging characteristics with little or no background development of the photoconductor; avoidance of filming of a metering blade and/or development roller (for a mono-component device) or the carrier bead (for a dual-component device), or of the photoconductor; high transfer efficiency from the photoconductor to the substrate or intermediate transfer belt or roller and from the transfer belt or roller (where used) to the substrate; efficient cleaning of any residual toner remaining after image transfer where a mechanical cleaning device is used.

The particle size distribution of the toner particles in a toner affects the quality of the final image. Ideally, a toner should be capable of forming an image with high resolution and high image density, without significant print defects such as fogging, ghosting, spotting and mottling. Furthermore, the toner should preferably not suffer from problems such as filming which also may be related, at least in part, to the particle size distribution.

The shape of a toner also may affect the toner's properties such as charge distribution, transfer efficiency and cleaning efficiency.

Toners are conventionally produced by melt kneading of a pigment, resin and other toner ingredients, followed by milling or pulverisation to produce toner sized particles. Classification is then needed to generate an acceptably narrow particle size distribution of the toner particles. Toners made by this conventional method tend to be of irregular shape.

More recently, attention has been focussed on chemical routes to toners, where a suitable particle size is not attained by a milling process, which thereby avoids the need for a classification step. By avoiding the classification step, less material is wasted and higher yields of toner can be attained, especially as the target particle size is reduced. Lower particle size toners are of considerable interest for a number of reasons, including better print resolution, lower pile height, greater yield from a toner cartridge, faster or lower temperature fusing, and lower paper curl.

Several chemical routes to toners have been exemplified in the prior art. These include suspension polymerisation, solution-dispersion processes and so-called aggregation processes. Aggregation processes in particular may provide good control over toner shape. Several aggregation processes are known, for example, as described in U.S. Pat. No. 4,996,127, U.S. Pat. No. 5,418,108, U.S. Pat. No. 5,066,560 and U.S. Pat. No. 4,983,488 and WO 98/50828. In aggregation processes, dispersed particles of resin and particles of colorant and optionally other particles and/or ingredients are associated to form larger, aggregate particles, which are useful as toner particles, optionally after further treatment such as heat treatment to fuse and/or shape the aggregate particles as desired.

However, it is still desirable to provide further processes for making toners which are capable of reliably forming toner having a narrow particle size distribution. Moreover, the toner so made should ideally possess as many of the above mentioned desirable properties of a toner as possible.

### SUMMARY OF THE INVENTION

According to one aspect of the present invention, there is provided a process for the manufacture of a toner comprising toner particles which comprise at least resin and colorant, the process comprising the steps of: providing a mixed dispersion of at least primary resin particles, primary colorant particles and a carboxy functional compound of Formula (1) and/or a salt thereof and/or a complex thereof in a liquid medium,

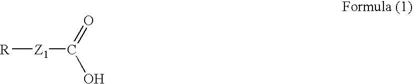

wherein R is a carbocyclic or heterocyclic group and Z₁ is a bond or a linker group,
the at least primary resin particles and primary colorant particles being stabilised by two or more surfactants in the liquid medium, the surfactants comprising at least a first ionic surfactant and a second ionic surfactant of the same polarity as the first ionic surfactant, wherein the first and second ionic surfactants have different linear chain lengths; and causing the primary particles to associate.

The present invention, in another aspect, provides a toner obtainable by the process.

The present invention, in still another aspect, provides the use of a toner obtainable by the process in electrophotography.

In a further aspect, the present invention provides an image forming method comprising the steps of: forming an electrostatic image on a photoconductive member; developing the electrostatic image with a toner to form a toner image; transferring the toner image onto a substrate, optionally via one or more intermediate transfer members; and fixing the toner image onto the substrate; wherein the toner is a toner according to the present invention.

In a still further aspect the present invention provides a two component developer comprising a toner according to the present invention and a magnetic carrier.

### DETAILED DESCRIPTION OF THE INVENTION

The process of the present invention is a chemical route to the manufacture of a toner and, in particular, is an aggregation process.

Advantageously, the process according to the present invention has been found to provide a manufacturing route to toners which is capable of reliably producing toners of narrow particle size distribution. In particular, the problems of having too high proportions of fine particles and/or coarse particles (grit) may be reduced compared to a similar process in which two ionic surfactants are not employed in the manner according to the present invention.

At the same time as providing a narrow particle size distribution, the process according to the present invention may satisfy many other requirements for a desirable process. The process may provide a great deal of control over the toner shape and, generally, no further treatment may be required to alter the shape. In particular, a shape may be provided, as desired, from substantially spherical to substantially irregular.

The term linear chain length herein means the longest chain length in a linear configuration within the surfactant molecule. All atoms are counted in the chain length (e.g. C, O, N, S) except for H. For the avoidance of doubt, any counter-ion(s) associated with the ionic surfactant are ignored in counting the linear chain length. For example, in the following ionic surfactant molecule, where R represents C₁₂ linear alkyl (i.e. an n-dodecyl group) and EO represents an ethylene oxide unit: —(CH₂CH₂O)— (i.e. wherein each EO unit has a chain length of 3 atoms), the atoms in the longest linear chain are counted as shown, making a linear chain length in this case of 46.

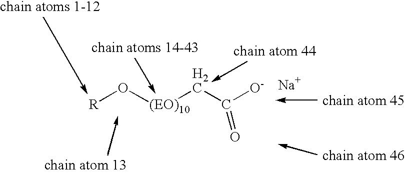

In cases where the surfactant contains one or more rings in the structure (e.g. a phenyl ring), the ring is counted in the following way for the purposes of the linear chain length:

For terminal rings, thus:

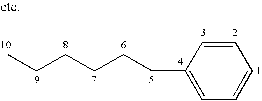

For in-chain rings, thus:

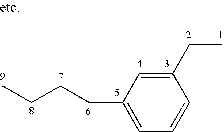

Herein, the first ionic surfactant will be denoted as the surfactant with the longer linear chain length and the second ionic surfactant will be denoted as the surfactant with the shorter linear chain length of the two.

Preferably, the first ionic surfactant has a linear chain length of 40 or more. Preferably, the first ionic surfactant has a linear chain length not greater than 60, more preferably not greater than 50. Accordingly, the first ionic surfactant in particularly preferred embodiments has a linear chain length in the range from 40 to 60, more particularly preferably from 40 to 50.

Preferably, the second ionic surfactant has a linear chain length less than 40, preferably not greater than 35 and more preferably not greater than 30. Preferably, the second ionic surfactant has a linear chain length of at least 10, more preferably at least 12, still more preferably at least 15 and most preferably at least 20. Accordingly, the second ionic surfactant in particularly preferred embodiments has a linear chain length of at least 10 and less than 40. More particularly preferred ranges for the linear chain length of the second ionic surfactant (in order of increasing preference) are: from 12 to 35; from 15 to 35; from 15 to 30; from 20 to 35; and from 20 to 30.

Preferably, in the mixed dispersion the amount of the second ionic surfactant (i.e. the surfactant with the shorter linear chain length) present is less than the amount of the first ionic surfactant.

Preferably, the amount of the second ionic surfactant (i.e. the surfactant with the shorter linear chain length) in the mixed dispersion is at least 0.1% by weight, based on the total solids content of the mixed dispersion (i.e. based on the weight of the resin, colorant, first and second ionic surfactants, carboxy functional compound, optional wax, optional CCA and any further surfactants) and more preferably at least 0.5% by weight. Preferably, the amount of the second surfactant in the mixed dispersion is not more than 5% by weight, more preferably not more than about 3% by weight and most preferably not more than about 2% by weight. Accordingly, in particularly preferred embodiments, the amount of the second ionic surfactant is present in an amount in the range from 0.1 to 5% by weight, more preferably from 0.5 to 3% by weight and most preferably from 0.5 to 2% by weight.

Preferably, the amount of the first ionic surfactant (i.e. the surfactant with the longer linear chain length) in the mixed dispersion is at least 1% by weight, based on the total solids content of the mixed dispersion, more preferably at least 2% by weight and most preferably at least 3% by weight. Preferably, the amount of the first surfactant in the mixed dispersion is not more than 10% by weight, more preferably not more than about 8% by weight and most preferably not more than about 6% by weight. Accordingly, in particularly preferred embodiments, the amount of the first ionic surfactant is present in an amount in the range from 1 to 10% by weight, more preferably from 2 to 8% by weight and most preferably from 3 to 6% by weight.

In preferred embodiments, the mixed dispersion is formed by a process comprising: providing a resin dispersion of the primary resin particles stabilised by at least one of the first and second ionic surfactants in a liquid medium; providing a colorant dispersion of the primary colorant particles stabilised by at least one of the first and second ionic surfactants in a liquid medium, the colorant dispersion optionally containing the carboxy functional compound and/or salt and/or complex thereof; and mixing the resin and colorant dispersions, optionally together with the other of the first and second ionic surfactants if only one of the ionic surfactants is used to stabilise the particles in both the resin and colorant dispersions and optionally together with the carboxy functional compound and/or salt and/or complex thereof where it is not contained in the colorant dispersion, thereby forming the mixed dispersion.

In embodiments, the mixed dispersion may be formed by a process wherein: the primary resin particles of the resin dispersion are stabilised by one of the first and second ionic surfactants; the primary colorant particles of the colorant dispersion are stabilised by the other of the first and second ionic surfactants; and the resin and colorant dispersions are mixed to form the mixed dispersion.

In further embodiments, the mixed dispersion may be formed by a process wherein: the primary resin particles of the resin dispersion are stabilised by both of the first and second ionic surfactants; the primary colorant particles of the colorant dispersion are stabilised by both of the first and second ionic surfactants; and the resin and colorant dispersions are mixed to form the mixed dispersion.

In still further embodiments, the mixed dispersion may be formed by a process wherein: one of the resin dispersion and the colorant dispersion has its primary particles stabilised by one of the first and second ionic surfactants and the other dispersion has its primary particles stabilised by both of the first and second ionic surfactants; and thereafter the resin and colorant dispersions are mixed to form the mixed dispersion.

In more preferred embodiments, the mixed dispersion is formed by a process comprising: providing a resin dispersion of the primary resin particles stabilised by at least the first ionic surfactant (i.e. the surfactant with the longer linear chain length) in a liquid medium; providing a colorant dispersion of the primary colorant particles stabilised by at least the first ionic surfactant in a liquid medium, the colorant dispersion optionally containing the carboxy functional compound and/or salt and/or complex thereof; and mixing the resin and colorant dispersions together with an amount of the second ionic surfactant and optionally together with the carboxy functional compound and/or salt and/or complex thereof where it is not contained in the colorant dispersion, thereby forming the mixed dispersion. In a most preferred embodiment, substantially all of the second surfactant is added at the same time as or after mixing the resin and colorant dispersions (i.e. not before). Accordingly, in a most preferred embodiment, the mixed dispersion is formed by a process comprising: providing a resin dispersion of the primary resin particles stabilised by an ionic surfactant which essentially consists of the first ionic surfactant in a liquid medium; providing a colorant dispersion of the primary colorant particles stabilised by an ionic surfactant which essentially consists of the first ionic surfactant in a liquid medium, the colorant dispersion optionally containing the carboxy functional compound and/or salt and/or complex thereof; and mixing the resin and colorant dispersions together with the second ionic surfactant and optionally together with the carboxy functional compound and/or salt and/or complex thereof where it is not contained in the colorant dispersion, thereby forming the mixed dispersion. Preferably, the amount of the second ionic surfactant added in this process is at least 0.1% by weight, based on the total solids content of the mixed dispersion and more preferably at least 0.5% by weight. Preferably, the amount of the second surfactant in the mixed dispersion is not more than 5% by weight, more preferably not more than about 3% by weight and most preferably not more than about 2% by weight. Accordingly, in particularly preferred embodiments, the amount of the second ionic surfactant is present in an amount in the range from 0.1 to 5% by weight, more preferably from 0.5 to 3% by weight and most preferably from 0.5 to 2% by weight.

In each embodiment, optionally, a further amount of the first and/or second ionic surfactant may be added at the same time as or after mixing the resin and colorant dispersions.

One or more further ionic surfactants may be provided in addition to the first and second ionic surfactants to stabilise the above described resin dispersion, colorant dispersion and/or mixed dispersion, which further ionic surfactant(s) may have the same or different linear chain length(s) as either of the first and second ionic surfactants. The further ionic surfactant(s) preferably has/have an ionic state of the same polarity as the first and second ionic surfactants.

Suitable ionic surfactants for use as the first and second ionic surfactants and optionally further ionic surfactants include known anionic and cationic surfactants. Examples of suitable anionic surfactants are: alkyl benzene sulphonates (e.g. sodium dodecylbenzene sulphonate); alkyl sulphates; alkyl ether sulphates; sulphosuccinates; phosphate esters; fatty acid carboxylates, including alkyl carboxylates; and alkyl or aryl alkoxylated carboxylates, which include, for example, alkyl ethoxylated carboxylates, alkyl propoxylated carboxylates and alkyl ethoxylated/propoxylated carboxylates. Examples of suitable cationic surfactants are: quaternary ammonium salts; benzalkonium chloride; ethoxylated amines.

In a preferred embodiment, the first and second ionic surfactants are anionic surfactants, especially anionic surfactants having a carboxylate group. More preferred still are the fatty acid carboxylates, including alkyl carboxylates and alkyl or aryl alkoxylated carboxylates. Examples of fatty acid carboxylates include salts of lauric acid, myristic acid, palmitic acid, stearic acid, oleic acid and the like. Most preferred still are the alkyl alkoxylated carboxylates, such as, e.g., alkyl ethoxylated carboxylates, alkyl propoxylated carboxylates and alkyl ethoxylated/propoxylated carboxylates, especially wherein the alkyl is C₈₋₁₄ alkyl. Suitable alkyl alkoxylated carboxylates are commercially available, such as in the Akypo™ range of surfactants from Kao Corporation and the Marlowet™ range of surfactants from Sasol.

Preferred first and second ionic surfactants are alkyl or aryl alkoxylated carboxylates represented by Formula A below:

R^{a}—O—(Z)ₘ—CH₂—CO₂⁻M⁺ Formula A

wherein:
R^{a} represents an optionally substituted alkyl or aryl group;
Z represents an alkylene oxide group;
m is an integer from 1 to 20; and
M⁺ represents a monovalent cationic counter-ion.

Preferably, in Formula A, R^{a} represents an optionally substituted alkyl group. The optionally substituted alkyl group is preferably a C₁₋₂₀ alkyl group, more preferably a C₄₋₁₈ alkyl group, still more preferably a C₆₋₁₆ alkyl group and most preferably a C₈₋₁₄ alkyl group. Preferably the R^{a} alkyl group is unsubstituted.

Preferably, Z represents an ethylene oxide (EO) or propylene oxide (PO) group. Each Z (where m is greater than 1) may be the same alkylene oxide group, e.g. each Z may be EO or each Z may be PO. Alternatively, each Z may independently represent, different alkylene oxide groups, such as EO or PO, such that the different alkylene oxide units (e.g. EO and PO units) may be randomly positioned in the —(Z)ₘ-chain.

Preferably, m is an integer from 2-16, more preferably from 3-12 and most preferably from 4-10.

Preferably, M⁺ represents an alkali metal cation or an ammonium cation. More preferably, M⁺ represents Li⁺, Na⁺, K⁺ or NH₄⁺ (especially Na⁺).

In preferred embodiments, the first ionic surfactant preferably has a Formula A above and a linear chain length of 40 or more, more preferably not greater than 60 and most preferably not greater than 50. Accordingly, in more preferred embodiments, the first ionic surfactant preferably has a Formula A is above and a linear chain length in the range from 40 to 60 and especially from 40 to 50. In even more preferred embodiments, the first ionic surfactant has a Formula A wherein: R^{a} is a C₁₀₋₁₄ alkyl group, more preferably a C₁₂₋₁₄ alkyl group; each Z independently represents an ethylene oxide or propylene oxide group, more preferably an ethylene oxide group; and m is 8 to 12, preferably 8 to 10, especially 10. A commercially available surfactant of this type is AKYPO™ RLM 100 available from Kao Corporation.

In preferred embodiments, the second ionic surfactant has a Formula A above and has a linear chain length less than 40, preferably not greater than 35 and more preferably not greater than 30. Preferably, the second ionic surfactant has a Formula A above and a linear chain length of at least 10, more preferably at least 12, still more preferably at least 15 and most preferably at least 20. Accordingly, in more preferred embodiments the second ionic surfactant has a Formula A above and has a linear chain length of at least 10 and less than 40, with more preferred ranges being (in order of increasing preference): from 12 to 35; from 15 to 35; from 15 to 30; from 20 to 35; and from 20 to 30. In even more preferred embodiments, the second ionic surfactant has a Formula A wherein: R^{a} is a C₈₋₁₂ alkyl group, more preferably a C₈₋₁₀ alkyl group; each Z independently represents an ethylene oxide or propylene oxide group; and m is 2 to 6, preferably 3 to 5, especially 4. A commercially available surfactant of this type is Marlowet™ 4539 available from Sasol.

One or more non-ionic surfactants may be additionally employed to stabilise the above described resin dispersion, colorant dispersion and/or mixed dispersion. Examples of suitable non-ionic surfactants include: alkyl ethoxylates; alkyl propoxylates; alkyl aryl ethoxylates; alkyl aryl propoxylates; and ethylene oxide/propylene oxide copolymers. Suitable commercially available non-ionic surfactants include the Solsperse™ range of surfactants from Noveon.

The first and second ionic surfactants are preferably reversibly ionisable ionic surfactants. By the term reversibly ionisable surfactants is meant that the surfactants may be changed from their ionic state to a non-ionic (i.e. neutral) state and vice versa. The change in ionisation state of the ionic surfactants may be effected, for example, by a change in pH of the liquid medium. By changing the pH of the liquid medium the first and second ionic surfactants may be switched from their dispersion stabilising ionic state to a non-stabilising non-ionic state thereby causing the primary particles in the mixed dispersion to associate. Preferred reversibly ionisable ionic surfactants include surfactants having a carboxylate group (i.e. an ionised carboxylic acid group), which are reversibly convertible by a pH change between an ionised, anionic carboxylate state and a neutral, protonated acid state. Other preferred reversibly ionisable ionic surfactants include surfactants having ammonium groups, which are reversibly convertible by a pH change between a neutral, amine state and an ionised, cationic ammonium state. Most preferred reversibly ionisable ionic surfactants are surfactants which are carboxylates such as, for example, the fatty acid carboxylates, including alkyl carboxylates; and alkyl alkoxylated carboxylates described above. In especially preferred embodiments, both the first and second ionic surfactants are reversibly ionisable carboxylate surfactants.

The liquid medium in each dispersion described above preferably comprises or is water, i.e. the dispersion formed is aqueous. However, depending on the dispersion requirements, the liquid medium in any dispersion may comprise an organic solvent, water or a mixture of these. Suitable organic solvents for forming dispersions are known in the art.

The toner preferably comprises other ingredients in addition to resin and colorant. Accordingly, in preferred embodiments, the mixed dispersion further comprises other ingredients as required by the composition of the final toner particles. Preferably, the toner further comprises a release agent, such as a wax, and/or a charge control agent (CCA). Thus, desirably, the mixed dispersion further comprises primary wax particles which are preferably also stabilised by the two or more ionic surfactants in the liquid medium and which are subsequently associated with the resin and colorant particles. Desirably, the mixed dispersion may also comprise a charge control agent (also referred to herein as CCA), as described in more detail below.

In especially preferred embodiments of the process of the present invention, the mixed dispersion further comprises primary wax particles in addition to the primary resin particles and primary colorant particles. In such embodiments, the mixed dispersion is formed by a process comprising: providing a resin dispersion of the primary resin particles stabilised by at least one of the first and second ionic surfactants in a liquid medium as described above; providing a colorant dispersion of the primary colorant particles stabilised by at least one of the first and second ionic surfactants in a liquid medium as described above, the colorant dispersion optionally containing the carboxy functional compound and/or salt and/or complex thereof; providing a wax dispersion of the primary wax particles stabilised by at least one of the first and second ionic surfactants in a liquid medium; and mixing the resin, colorant and wax dispersions, optionally together with the other of the first and second ionic surfactants if only one of the surfactants is used to stabilise the particles in each of the resin, colorant and wax dispersions and optionally together with the carboxy functional compound and/or salt and/or complex thereof where it is not contained in the colorant dispersion, thereby forming the mixed dispersion.

In more especially preferred embodiments of the process of the present invention, the mixed dispersion is formed by a process comprising: providing a resin dispersion of the primary resin particles stabilised by at least the first ionic surfactant in a liquid medium as described above; providing a colorant dispersion of the primary colorant particles stabilised by at least the first ionic surfactant in a liquid medium as described above, the colorant dispersion optionally containing the carboxy functional compound and/or salt and/or complex thereof; providing a wax dispersion of the primary wax particles stabilised by at least the first ionic surfactant in a liquid medium; and mixing the resin, colorant and wax dispersions, together with an amount of the second ionic surfactant and optionally together with the carboxy functional compound and/or salt and/or complex thereof where it is not contained in the colorant dispersion, thereby forming the mixed dispersion. In the foregoing especially preferred embodiments, the mixed dispersion is also provided with a charge control agent, which is also mixed with the resin, colorant and wax dispersions, or is part of the colorant dispersion. In a more preferred embodiment still, substantially all of the second surfactant is added at the same time as or after mixing the resin, colorant and wax dispersions (i.e. not before). Accordingly, in a most preferred embodiment, the mixed dispersion is formed by a process comprising: providing a resin dispersion of the primary resin particles stabilised by an ionic surfactant which essentially consists of the first ionic surfactant in a liquid medium; providing a colorant dispersion of the primary colorant particles stabilised by an ionic surfactant which essentially consists of the first ionic surfactant in a liquid medium, the colorant dispersion optionally containing the carboxy functional compound and/or salt and/or complex thereof; providing a wax dispersion of the primary wax particles stabilised by an ionic surfactant which essentially consists of the first ionic surfactant in a liquid medium; and mixing the resin, colorant and wax dispersions together with the second ionic surfactant and optionally together with the carboxy functional compound and/or salt and/or complex thereof where it is not contained in the colorant dispersion, thereby forming the mixed dispersion. Preferably, the amount of the second ionic surfactant added in this process is at least 0.1% by weight, based on the total solids content of the mixed dispersion and more preferably at least 0.5% by weight. Preferably, the amount of the second surfactant in the mixed dispersion is not more than 5% by weight, more preferably not more than about 3% by weight and most preferably not more than about 2% by weight. Accordingly, in particularly preferred embodiments, the amount of the second ionic surfactant is present in an amount in the range from 0.1 to 5% by weight, more preferably from 0.5 to 3% by weight and most preferably from 0.5 to 2% by weight.

Further preferred features of the present invention are now described.

The carboxy functional compound is of Formula (1):

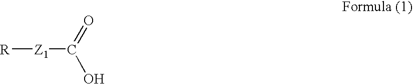

wherein R is a carbocyclic or heterocyclic group and Z₁ is a bond or a linker group. The carboxy functional compound of Formula (1) is termed herein the carboxy functional compound.

The carboxy functional compound may be provided in acid (i.e. protonated) form, in salt form, in complex form (as hereinafter defined) or a mixture of two or more of these forms. Accordingly, all the Formulae shown herein for the carboxy functional compound (including in the claims) and references to the compound encompass the compound in acid, salt and/or complex form, unless otherwise stated.

The carboxy functional compound is preferably in salt and/or complex form in the mixed dispersion, prior to association.

The total amount of carboxy functional compound of Formula (1) and/or a salt and/or complex thereof (i.e. in all forms) is preferably in the range 0.1-10% based on the total solids content of the mixed dispersion. More preferably, the amount of carboxy functional compound of Formula (1) and/or a salt and/or complex thereof is at least about 1% by weight, more preferably at least about 2% by weight, still more preferably at least about 3% by weight. Preferably, the amount of carboxy functional compound of Formula (1) and/or a salt and/or complex thereof provided is up to about 5% by weight. Accordingly, preferred ranges for the amount of the carboxy functional compound of Formula (1) are (in order of increasing preference): 1 to 10%, 1 to 5%, 2 to 5% and 3 to 5% by weight. The presence of the carboxy functional compound of Formula (1) and/or a salt and/or complex thereof in the process may also assist in the narrowing of the particle size distribution of the toner.

The carboxy functional compound, in complex form (as hereinafter defined), may function as a charge control agent. Preferably, the amount of carboxy functional compound of Formula (1) provided which is in complex form is at least about 0.5%, more preferably at least about 1% by weight and most preferably at least about 2% by weight based on the total solids content of the mixed dispersion. Preferably, the amount of carboxy functional compound of Formula (1) provided which is in complex form is up to about 4%, more preferably up to about 3% by weight. Accordingly, preferred ranges for the amount of the carboxy functional compound of Formula (1) which is in complex form are (in order of increasing preference): 0.5 to 4%, 1 to 4% 1 to 3% and 2 to 3% by weight.

Preferably, an amount of the carboxy functional compound is present in the acid and/or salt form (especially salt form). This form of the compound has been found to assist in the production of toners of narrow particle size distribution. Preferably, the amount of carboxy functional compound of Formula (1) provided which is in acid and/or salt form (especially salt form) is at least about 0.5%, more preferably at least about 1.0% by weight based on the total solids content of the mixed dispersion. Preferably, the amount of carboxy functional compound of Formula (1) provided which is in acid and/or salt form (especially salt form) is up to about 5%, more up to about 4%, still more preferably up to about 3% by weight and most preferably up to about 2% by weight. Accordingly, preferred ranges for the amount of the carboxy functional compound of Formula (1) which is in acid and/or salt form (especially salt form) are (in order of increasing preference): 0.5 to 5%, 0.5 to 4%, 1 to 4%, 1 to 3% and 1 to 2% by weight.

In especially preferred embodiments, there is provided an amount of the carboxy functional compound of Formula (1) and/or a salt and/or complex thereof which is 1 to 10% by weight (preferably 1 to 5% by weight), wherein an amount of the carboxy functional compound in complex form is in the range 1 to 4% by weight (preferably 1 to 3%) and an amount of the carboxy functional compound of Formula (1) which is in acid and/or salt form (especially salt form) is in the range 1 to 4% by weight (preferably 1 to 3%) wherein the amounts (in % by weight) are based on the total solids content of the mixed dispersion.

In Formula (1), R is a carbocyclic or heterocyclic group, each of which may be optionally substituted. The term carbocyclic group herein means a group wherein the atoms linked to form the carbocyclic ring are all carbon atoms. The term heterocyclic group herein means a group wherein the atoms linked to form the heterocyclic ring comprise one or more heteroatoms selected from S, O and N.

The carbocyclic group may be an aliphatic or aromatic group. The group may be monocyclic (e.g. phenyl) or polycyclic (e.g. naphthyl). Examples of aromatic group include phenyl or naphthyl. Examples of aliphatic group include cycloalkyl (e.g. cyclohexyl), cycloalkenyl (e.g. cyclohexenyl) and cycloalkynyl (e.g. cyclohexynyl).

The heterocyclic group may be a heteroaromatic group. Examples of heteroaromatic group include pyridinyl, diazinyl, triazinyl or quinolinyl. Other examples of heterocyclic group include piperidinyl.

Preferably, R is an optionally substituted carbocyclic aromatic group. More preferably, R is optionally substituted phenyl or naphthyl (including 1-naphthyl and 2-naphthyl, preferably 2-naphthyl), so that the carboxy functional compound may be represented thus:

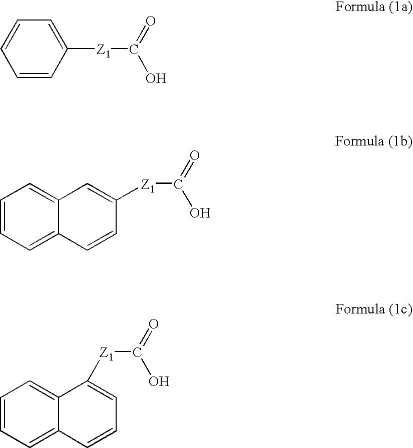

wherein the phenyl or naphthyl groups of Formulae (1a)-(1c) may optionally be substituted with further substituents. Preferably, the carboxy functional compound is of Formula (1a) or (1 b).

Z₁ is a bond (i.e. where the carboxy group is attached directly to R) or linker group. Where Z₁ is a linker group it spaces the carboxy group by no more than 3 atoms from R, i.e. the linker has a chain length of no more than 3 atoms (e.g. Z₁ may be —CH₂CH₂CH₂— or —O—CH₂CH₂—). Where Z₁ is a linker group it preferably spaces the carboxy group by no more than 2 atoms from R (e.g. Z₁ may be —₂CH₂—) and most preferably 1 atom from R (e.g. Z₁ may be —₂— or —O—). Most preferably, Z₁ is a bond. Thus, the carboxy functional compound a Formula R—COOH where Z₁ is a bond. Thus, the Formulae (1a)-(1c) are preferably of Formulae (1a′)-(1 c′):

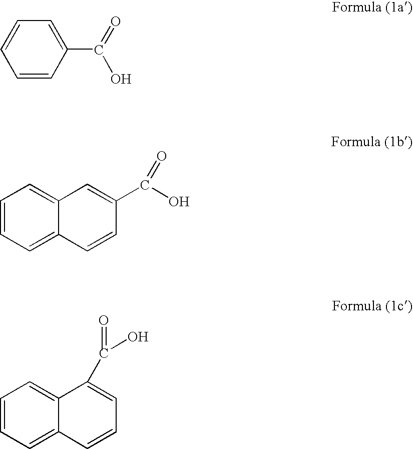

wherein the phenyl or naphthyl groups of Formulae (1a′)-(1c′) may optionally be substituted with further substituents.

As mentioned, the carboxy functional compound of Formula (1) may be provided as an acid (i.e. protonated form), as a salt, as a complex, or as a mixture of two or more of these. In preferred embodiments, the carboxy functional compound is substantially provided in salt form and/or complex form.

The salt form may be a salt of a metal or non-metal species (e.g. ammonium ion). Preferably, the salt is a salt of a metal. The metal with which the carboxy functional compound may form a metal salt may be any suitable metal. In particular, the metal may comprise a group IA metal (e.g. lithium, sodium or potassium).

In the salt form of the carboxy functional compound, the carboxy group, or groups if more than one, is preferably present in an ionic form, i.e. —CO₂⁻M⁺ wherein M⁺ represents a metal ion or ammonium ion. Preferably M⁺ is selected from Li⁺, Na⁺, K⁺ and NH₄⁺. For the avoidance of doubt, the term salt herein excludes a complex as hereinafter defined. Typically, therefore, the salt has a ratio of carboxy functional compound:metal of 1:1 or less (e.g. 1:2, such as where there are two or more carboxy groups in the compound). More typically, the salt has a ratio of carboxy functional compound:metal of 1:1.

The term complex herein means a metal complex wherein the ratio of carboxy functional compound:metal is 2:1 or higher (e.g. 3:1), preferably 2:1. The metal of the complex may be a transition metal (e.g. titanium, vanadium, chromium, manganese, iron, cobalt, nickel, copper, zinc or zirconium) or a group IIIB metal (e.g. aluminium or gallium). Preferred metal species with which the carboxy functional compound may form a metal complex are selected from aluminium, chromium, manganese, iron, cobalt, nickel, copper or zinc (especially aluminium, zinc and chromium). Especially preferred complexes have a ratio of carboxy functional compound:metal of 2:1, wherein the metal is aluminium, zinc or chromium. More especially preferred complexes are those of a carboxy functional compound of the following Formula:

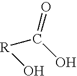

and particularly those of Formula (7) or (8) below (most of all Formula (7)).

Preferably, the carboxy functional compound and/or a salt and/or complex thereof further carries at least one additional ionisable group (i.e. in addition to the carboxy group in Formula (1)). More preferably, the additional ionisable group may also be capable of forming a salt or of coordinating to a metal species with which the compound may form a complex. Preferred additional ionisable groups include another COOH, OH, NH₂ or SH and most preferred is OH. Preferably, the additional ionisable group is carried on R. In other words, preferably R carries both the —Z₁-CO₂H group and the additional ionisable group (which is preferably OH). The additional ionisable group may be attached directly to R or via a linker group, which may be any known linker group including those examples of linker groups for Z₁ described above.

In view of the above preferences, a preferred carboxy functional compound is of Formula (2):

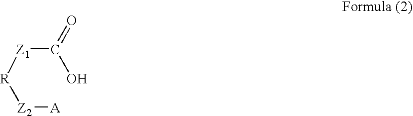

where Z₂ is a bond or linker group and A is an ionisable group.

Z₂ is a bond (i.e. where A is attached directly to R) or linker group. Where Z₂ is a linker group it spaces the carboxy group by no more than 3 atoms from R, i.e. the linker has a chain length of no more than 3 atoms (e.g. Z₂ may be —CH₂CH₂CH₂— or —O—CH₂CH₂—). Where Z₂ is a linker group it preferably spaces the carboxy group by no more than 2 atoms from R (e.g. Z₂ may be —CH₂CH₂— or —O—CH₂—) and most preferably 1 atom from R (e.g. Z₂ may be —CH₂— or —O—). Most preferably, Z₂ is a bond.

Especially, both Z₁ and Z₂ are each a bond. The carboxy functional compound is thus especially of the following Formula:

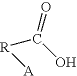

and most especially of the following Formula:

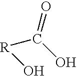

A is preferably an ionisable group selected from the group consisting of COOH, OH, NH₂ or SH and most preferably A is OH.

Most preferably, the —Z₁—CO₂H and —Z₂-A groups are attached to R at adjacent ring positions. This positioning may facilitate coordination of the CO₂H and A groups to the metal species with which the compound may form a complex. For instance, in the preferred embodiments where R is phenyl or naphthyl, preferably the carboxy functional compound has a Formula (3) or (4):

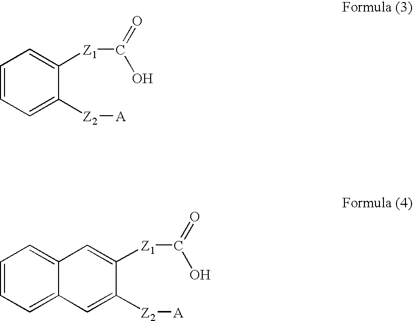

more preferably, a Formula (5) or (6):

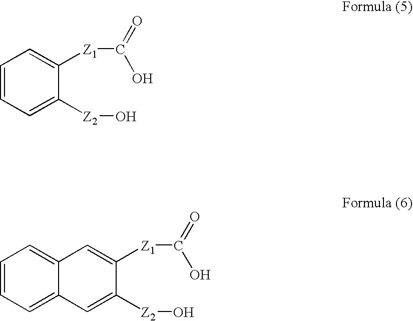

and most preferably, a Formula (7) or (8):

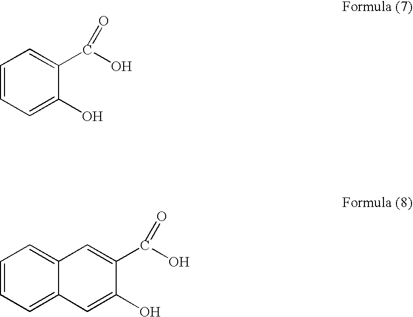

wherein in Formulae (3)-(8) the phenyl or naphthyl groups may optionally be substituted with further substituents. In formulae herein, the —OH group may be in the form —O⁻M⁺, where M⁺ is as defined above.

The optional substituents for R do not contain more than 6, preferably do not contain more than 4, carbon atoms. The optional substituents for R (therefore including for the phenyl and naphthyl groups of Formulae (1a)-(1c) and (3)-(8)), Z₁ and Z₂ are preferably selected from the following list: optionally substituted C₁₋₆ alkyl (especially optionally substituted C₁₋₄ alkyl), optionally substituted cyclohexyl, optionally substituted C₁₋₆ alkoxy (especially optionally substituted C₁₋₄ alkoxy), optionally substituted phenyl, optionally substituted heteroaryl, optionally substituted phenoxy, optionally substituted amino, hydroxyl, halo, cyano, nitro, silyl, silyloxy, azo, sulpho (i.e. SO₃H), phosphato (i.e. PO₃H₂), —COOR¹, —OCOOR¹, —OCOR¹, —COR¹, —CONR¹R², —OCONR¹R², —SR¹, —SO₂NR¹R², or —SO₂R¹, wherein R¹ and R² each independently represent H, optionally substituted C₁₋₄ alkyl or optionally substituted phenyl. When any substituent group from the foregoing list is itself described as being optionally substituted, it may be substituted with any of the substituents from the same list. Groups such as sulpho, phosphato and carboxy (i.e. COOH) may be present in a salt form (e.g. COO⁻Na⁺). It will be appreciated from the foregoing list that, in addition to the —Z₁—CO₂H and —Z₂-A groups, R may be substituted still further by additional —CO₂H or A groups. A preferred optional substituent for R is optionally substituted alkyl (especially C₁₋₄ alkyl), e.g. methyl, ethyl, propyl, isopropyl, n-butyl and tert-butyl.

Preferred examples of the carboxy functional compound suitable for use in the present invention include the following (and their salts and complexes):
salicylic acid;
substituted salicylic acids;
alkyl substituted salicylic acids (e.g. di-tertbutylsalicylic acid);
naphthoic acid;
substituted naphthoic acids;
alkyl substituted naphthoic acids;
hydroxy naphthoic acids, especially 2-hydroxy-3-naphthoic acids (e.g. “bon acid”);
substituted hydroxy naphthoic acids, especially substituted 2-hydroxy-3-naphthoic acids;
alkyl substituted hydroxy naphthoic acids, especially alkyl substituted 2-hydroxy-3-naphthoic acids.

More preferred examples among these include optionally substituted salicylic acids, especially alkyl substituted salicylic acids (e.g. di-tertbutylsalicylic acid) and optionally substituted hydroxy naphthoic acids, especially optionally substituted 2-hydroxy-3-naphthoic acids (e.g. “bon acid”). In more preferred embodiments, the invention employs a salt and/or complex of these examples of carboxy functional compound. Commercial products include Bontron™ E81, E82, E84 and E88 (Orient Chem. Co.) and LR 147 (Japan Carlit).

There may be provided a mixture of two or more of the carboxy functional compounds and/or salts and/or complexes thereof. Preferred combinations of the carboxy functional compounds and/or salts and/or complexes thereof include a mixture of an optionally substituted salicylic acid (e.g. di-tertbutylsalicylic acid) and an optionally substituted hydroxy naphthoic acid, especially an optionally substituted 2-hydroxy-3-naphthoic acid (e.g. bon acid), either or both of which preferably may be provided in salt and/or complex form. Especially preferred combinations include a combination of an optionally substituted salicylic acid in complex form and an optionally substituted hydroxy naphthoic acid in salt form.

All or at least a portion of the carboxy functional compound may be milled with the colorant, so as to form part of the colorant dispersion. Alternatively or additionally, at least a portion of the carboxy functional compound may be provided separately before mixing with the dispersions in the mixing step. Preferably, at least a portion, more preferably all, of the carboxy functional compound and/or salt and/or complex thereof is initially provided separately from the colorant dispersion. Where at least a portion of the carboxy functional compound and/or salt and/or complex thereof is provided separately from the colorant dispersion it may be provided, for example, as a wet-cake or solution is (especially an aqueous wet-cake or solution). The wet-cake or solution is preferably a wet-cake or solution of the carboxy functional compound in salt or complex form. Where at least a portion of the carboxy functional compound and/or salt and/or complex thereof is provided separately it is preferably provided as a wet cake. The solids content of the wet cake or solution is preferably at least 10% by weight, e.g. 10-50% by weight and preferably 10-30% by weight. Where the carboxy functional compound is provided separately it is then mixed with the other dispersions in the mixing step to form the mixed dispersion.

Additional surfactant (i.e. additional to the surfactants present as part of the resin, colorant and optional wax dispersions) may be added, e.g. at the stage of mixing the dispersions to form the mixed dispersion. The process preferably comprises mixing any additional surfactant with the resin dispersion, colorant dispersion, optional wax dispersion and carboxy functional compound. The additional surfactant may be provided with the carboxy functional compound (e.g. as part of a wet-cake) or provided separately. Preferably, the additional surfactant is an ionic surfactant, more preferably an ionic surfactant with the same polarity as the surfactants used to stabilise the resin, colorant and optional wax dispersions and most preferably is the same ionic surfactant as one of the first and second ionic surfactants (especially it is more of the first ionic surfactant). The amount of any additional surfactant provided is preferably in the range 0.1 to 10% (more preferably 0.5 to 8% and most preferably 0.5 to 5%) by weight based on the total solids content of the mixed dispersion.

The resin dispersion contains primary resin particles which are particles of the resin (also termed binder resin in the art) which goes to make up the bulk of the toner.

Preferably, the resin dispersion is a dispersion of the resin particles in water, i.e. is an aqueous dispersion. The resin dispersion preferably comprises at least one of the first and second ionic surfactants, more preferably the first (i.e. longer chain) ionic surfactant to stabilise the resin particles in dispersion. Optionally, a non-ionic surfactant may also be incorporated into the resin dispersion.

Examples of anionic surfactants are: alkyl aryl sulphonates (e.g. sodium dodecylbenzenesulphonate); alkyl sulphates; alkyl ether sulphates; sulphosuccinates; phosphate esters; alkyl carboxylates; alkyl alkoxylate carboxylates such as alkyl ethoxylate carboxylates and alkyl propoxylate carboxylates. Examples of cationic surfactants are: quaternary ammonium salts; benzalkonium chloride; ethoxylated amines. Examples of non-ionic surfactants are: alkyl ethoxylates, alkyl propoxylates, alkyl aryl ethoxylates, alkyl aryl propoxylates, ethylene oxide/propylene oxide copolymers.

In one preferred form of the process according to the present invention, the association of primary particles is caused by a so-called pH switch process. Thus, at least one, preferably both of the first and second ionic surfactants contain a group which can be converted from a ionic form stabilising the primary particles in dispersion to a non-ionic form which is non-stabilising for the primary particles in dispersion (and vice versa) by adjustment of pH, i.e. the ionic surfactant is reversibly ionisable. Preferred such groups include carboxylate or ammonium groups, more preferred being carboxylate. In preferred embodiments, the ionic surfactant in the resin dispersion has a polarity (i.e. anionic or cationic) of the same sign as that of the ionic surfactant used in the colorant dispersion and optional wax dispersion. It is further preferred in such a case to use the same ionic surfactant for each of the dispersions. This enables the association step of the process to be performed by changing the pH in order to change the charge on the surfactant and thereby destabilise the dispersions and so cause association. In the foregoing preferred pH switch form of the process according to the present invention, the individual components of resin, colorant and optional wax, as well as other optional ingredients, can be particularly well mixed prior to inducing association, which, in turn, may lead to improved homogeneity of distribution of the components in the final toner. The pH switch embodiment furthermore may not require the addition of large quantities of salt or surfactant to induce association unlike other known aggregation processes.

The resin, e.g. in the resin dispersion, may be prepared by polymerisation processes known in the art, preferably by emulsion polymerisation.

The molecular weight of the resin can be controlled by use of a chain transfer agent (e.g. a mercaptan), by control of initiator concentration and/or by heating time.

The resin of the dispersion may comprise a single resin or may comprise a combination of two or more separate resins.

The resin(s) may be monomodal or bimodal in their molecular weight distribution. In one preferred embodiment, at least one resin with monomodal molecular weight distribution is combined with at least one resin with bimodal molecular weight distribution. By a resin with a monomodal molecular weight distribution is meant one in which the gpc spectrum shows only one peak. By a resin with a bimodal molecular weight distribution is meant one where the gpc spectrum shows two peaks, or a peak and a shoulder.

It is preferred that the overall molecular weight distribution of all the resin in the dispersion (i.e. the overall molecular weight distribution of the resin in the toner) shows Mw/Mn of 3 or more, more preferably 5 or more, most preferably 10 or more. The Tg of each resin is preferably from 30 to 100° C., more preferably is from 40 to 75° C., most preferably from 45 to 65° C. If the Tg is too low, the storage stability of the toner will be reduced. If the Tg is too high, the melt viscosity of the resin will be raised, which will increase the fixation temperature and the temperature required to achieve adequate transparency. It is preferred that all the components in the resin have a substantially similar Tg.

The resin particles may comprise particles made from one or more of the following preferred monomers for emulsion polymerisation: styrene and substituted styrenes; acrylate and methacrylate alkyl esters (e.g. butyl acrylate, butyl methacrylate, methyl acrylate, methyl methacrylate, ethyl acrylate or methacrylate, octyl acrylate or methacrylate, dodecyl acrylate or methacrylate etc.); acrylate or methacrylate esters with polar functionality, for example hydroxy or carboxylic acid functionality, hydroxy functionality being preferred (particularly 2-hydroxyethyl acrylate, 2-hydroxyethyl methacrylate, or hydroxy-terminated poly(ethylene oxide) acrylates or methacrylates, or hydroxy-terminated poly(propylene oxide) acrylates or methacrylates), examples of monomers with carboxylic acid functionality including acrylic acid and beta-carboxyethylacrylate; vinyl type monomers such as ethylene, propylene, butylene, isoprene and butadiene; vinyl esters such as vinyl acetate; other monomers such as acrylonitrile, maleic anhydride, vinyl ethers. The resin may comprise a co-polymer of two or more of the above monomers.

Preferred resins comprise a co-polymer of styrene and one or more (meth)acrylates (i.e. a styrene-(meth)acrylate resin).

Preferred resin particles comprise resin particles which are made from copolymers of (i) styrene or a substituted styrene (more preferably styrene), (ii) at least one alkyl acrylate or methacrylate and (iii) an acid-functional or hydroxy-functional acrylate or methacrylate (especially a hydroxy-functional acrylate or methacrylate).

The resin may comprise one or more of the following resins, not used in emulsion polymerisation: polyester, polyurethane, hydrocarbon polymer, silicone polymer, polyamide, epoxy resin and other resin known in the art as suitable for making toners.

Preferred resins comprise a co-polymer of styrene and one or more (meth)acrylates (i.e. a styrene-acrylate resin) and/or comprise a polyester resin.

The average size of the primary resin particles, as measured using photon correlation spectroscopy, is preferably less than 200 nm and more preferably less than 150 nm. It is preferably more than 50 nm. The average size of the primary resin particles may, for example lie in the range 80-120 nm.

The term colorant particles herein means any particles which are colored and accordingly includes particles which contain colorant as well as particles of colorant. For example, colorant particles may include, without limitation, pigment particles, pigmented particles such as pigmented resin particles (i.e. resin particles containing pigment therein), or dyed particles such as dyed resin particles (i.e. resin particles containing dye therein). More preferably, the colorant particles are pigment particles or pigmented particles (hereinafter collectively pigmentary particles). Most preferably, the primary colorant particles comprise primary pigment particles.

Preferably, the colorant dispersion is a dispersion in water i.e. is an aqueous dispersion. The colorant dispersion may be prepared by processes known in the art, preferably by milling the colorant with a surfactant in an aqueous medium.

Alternatively, an aqueous dispersion of colorant particles may be produced by a solution dispersion process in the following way. A polymer (e.g. polyester) is dissolved in an organic solvent. Preferably the solvent used should be immiscible with water, dissolve the polymer and/or be removable by distillation relatively easily. Suitable solvents comprise xylene, ethyl acetate and/or methylene chloride. To this solution is added a colorant, either a pigment or a dye. If a dye is used this is simply dissolved in the polymer solution to produce a colored liquid solution. If a pigment is used it may be added, preferably with one or more suitable pigment dispersants (which may be ionic or non-ionic). The colored polymer solution is then dispersed in water with a surfactant and the solvent removed by distillation to leave an aqueous dispersion of pigmentary particles containing the colorant dissolved or dispersed within the polymer.

The colorant dispersion preferably comprises one of the first and second ionic surfactants, more preferably the first ionic surfactant, to stabilise the colorant particles in dispersion. Optionally, a non-ionic surfactant may also be incorporated into the colorant dispersion. Examples of ionic and non-ionic surfactants for the colorant dispersion are as described above.

In the preferred embodiment of the process wherein the association is caused by the pH switch process described above, the colorant dispersion is stabilised with an ionic surfactant (preferably the first ionic surfactant), which has the same polarity as the ionic surfactant used for the resin dispersion and the optional wax dispersion and which is capable of being converted from an ionic to a non-ionic form (and vice versa) by a change in pH, i.e. is reversibly ionisable. Examples of such surfactants are described above.

The colorant may be of any color including black or white. The colorant may comprise a pigment or a dye. Preferably, the colorant comprises a pigment. Any suitable pigment known in the art can be used, including black and magnetic pigments. Chemical classes of pigments include, without limitation for example is carbon black, magnetite, copper phthalocyanine, quinacridones, xanthenes, mono- and dis-azo pigments, naphthols etc. Examples include CI Pigment Blue 15:3, CI Pigment Red 31, 57, 81, 122, 146, 147, 184 or 185; CI Pigment Yellow 12, 13, 17, 74, 83, 93, 150, 151, 155, 180 or 185. In full colour printing it is normal to use yellow, magenta, cyan and black toners. However it is possible to make specific toners for spot colour or custom colour applications.

The colorant is preferably present in an amount from 1-15% by weight based on the total solids content of the mixed dispersion, more preferably from 1.5-10% by weight, most preferably from 2-8% by weight. These ranges are most applicable for organic, non-magnetic pigments. If, for example, magnetite was used as a magnetic filler/pigment, the level would typically be higher than these ranges.

Preferably, in one embodiment of the process, the colorant dispersion is prepared by milling the colorant with the ionic surfactant described above, and optionally a non-ionic surfactant, until the particle size is suitably reduced.

Preferably, the volume average size of the primary colorant particle, which may be measured by a light scattering method, is less than 500 nm, more preferably less than 300 nm, still more preferably less than 200 nm and most preferably less than 100 nm. It is preferably more than 20 nm.

Preferably, the toner comprises wax. Accordingly, preferably, a wax dispersion is used in the process. The wax dispersion is preferably a dispersion in water i.e. is an aqueous dispersion. The wax dispersion is preferably prepared by the mixing together of a wax with the ionic surfactant to stabilise the wax particles in dispersion. Examples of ionic and optionally non-ionic surfactants for the wax dispersion are the same as for the resin and colorant dispersions described above.

In one preferred embodiment of the process wherein the association is caused by a pH switch process, the wax dispersion is stabilised with an ionic surfactant (preferably the first ionic surfactant), which has the same polarity as the ionic surfactant used for the resin dispersion and the colorant dispersion and which is capable of being converted from an ionic to a non-ionic form (and vice versa) by a change in pH, i.e. is reversibly ionisable. Examples of such surfactants are described above.

The wax should have a melting point (mpt) (as measured by the peak position by differential scanning calorimetry (dsc)) of from 50 to 150° C., preferably from 50 to 130° C., more preferably from 50 to 110° C., especially from 65 to 85° C. If the mpt is >150° C. the release properties at lower temperatures are inferior, especially where high print densities are used. If the mpt is <50° C. the storage stability of the toner will suffer, and the toner may be more prone to showing filming of the photoconductive component or metering blade.

The wax may comprise any conventionally used wax. Examples include hydrocarbon waxes (e.g. polyethylenes such as Polywax™ 400, 500, 600, 655, 725, 850, 1000, 2000 and 3000 from Baker Petrolite; paraffin waxes and waxes made from CO and H₂, especially Fischer-Tropsch waxes such as Paraflint™ C80 and H1 from Sasol; ester waxes, including natural waxes such as Carnauba and Montan waxes; amide waxes; and mixtures of these. Hydrocarbon waxes are preferred, especially Fischer-Tropsch, paraffin and polyethylene waxes. It is especially preferred to use a mixture of Fischer-Tropsch and Carnauba waxes, or a mixture of paraffin and Carnauba waxes.

The amount of wax present is preferably from 1 to 30% by weight based on the total solids content of the mixed dispersion, more preferably from 3 to 20% by weight, especially from 5 to 15% by weight. If the level of wax is too low, the release properties may be inadequate for oil-less fusion. Too high a level of wax will reduce storage stability and lead to filming problems. The distribution of the wax through the toner is also a significant factor, it being preferred that wax is substantially not present at the surface of the toner.

The volume average particle size of the primary wax particles, which may be measured by a light scattering method, in the dispersion is preferably in the range from 100 nm to 2 μm, more preferably from 100 to 800 nm, still more preferably from 150 to 600 nm, and especially from 150 to 500 nm. The wax particle size is chosen such that an even and consistent incorporation into the toner is achieved.

The process may be very efficient at incorporating a wax in the toner in order to improve its release properties as well as incorporating other components such as a charge control agent (CCA). The wax may be incorporated in the toner in relatively large amounts compared with some prior art processes and may be incorporated in uniformly sized wax domains, which may improve the transparency of prints formed by the toner.

Within the scope of the invention and claims, in embodiments, the resin dispersion, colorant dispersion and optional wax dispersion are separate dispersions which are then mixed. However, in certain embodiments, the primary resin particles may be prepared in a dispersion along with either or both of the primary colorant and/or wax particles, such that the resin, colorant and/or wax dispersions may be one and the same dispersion. It is also possible that the primary colorant and wax particles are prepared in one dispersion so that the colorant and wax dispersions are one and the same dispersion.

The process of the present invention may further comprise providing a charge control agent (CCA), in addition to a complex of a carboxy functional compound of Formula (1) which may function as a CCA. Such further CCA may be selected from such known classes of CCAs as metal azo complexes, phenolic polymers and calixarenes, nigrosine, quaternary ammonium salts, and arylsulphones. Preferred CCAs are colourless. The CCA may be provided as a component of one of the resin, colorant and wax dispersions (preferably the colorant dispersion) or the CCA may be provided separately and added as part of the mixed dispersion, preferably as a solution or wet cake. Additionally or alternatively, a CCA may be added externally to the toner prepared by the process, in which case a suitable high-speed blender may be used, e.g. a Nara Hybridiser or Henschel blender. Where the CCA is added externally it is preferably added to the dried toner.

Preferably, each dispersion in the process is a dispersion in an aqueous medium, more preferably in water.

Mixing of the dispersions to form the mixed dispersion may be performed by any conventional method of mixing dispersions. The mixing may include a low shear condition (e.g. using a low shear stirring means) and/or a high shear condition (e.g. using a rotor-stator type mixer). The mixed dispersions may be heated at a temperature below the glass transition temperature (Tg) prior to association of the particles.

The particles in the mixed dispersion may be caused to associate by any suitable method known in the art. For instance, the association may be caused by heating and stirring as described, for example, in U.S. Pat. No. 4,996,127, or by the addition of an association agent. The association agent may comprise an inorganic salt, an organic coagulant such as an ionic surfactant, or an acid or base. Known process include associating particles by the addition of an inorganic salt as described, for example, in U.S. Pat. No. 4,983,488 or by the action of organic coagulants, including counterionic surfactants as described, for example, in U.S. Pat. No. 5,418,108 and numerous other patents.

In a preferred process, the association is caused by a pH switch, i.e. by effecting a change in the pH of the dispersion, preferably either from a basic pH to an acidic pH or from an acidic pH to a basic pH. In such cases the association agent is an acid or base, designed to change the pH. Such association processes are described in WO 98/50828 and WO 99/50714. In this case, the ionic surfactant (i.e. the first and second ionic surfactant) is reversibly ionisable or de-ionisable, i.e. contains a group which can be converted from an ionic to a non-ionic form and vice versa by adjustment of pH. In a particularly preferred example, the ionic surfactant may contain a carboxylate group, and the mixed dispersion may be formed, e.g. by mixing the dispersions, at neutral to high pH (i.e. above neutral) with association then being effected by addition of an acid, which decreases the pH (i.e. below neutral and preferably to a pH below 4) and converts the ionic surfactant from its dispersion stabilising anionic carboxylate form to its non-stabilising non-ionic carboxylic acid form. Alternatively, in another preferred example, the ionic surfactant may contain a group which is the acid salt of a tertiary amine, and the mixed dispersion may be formed, e.g. by mixing the dispersions at neutral to low pH (i.e. below neutral) with association then being effected by addition of a base which increases the pH (i.e. above neutral and preferably to a pH above 8) and converts the surfactant from its dispersion stabilising cationic form to its non-stabilising non-ionic form. The pH switch processes allow a very efficient use of surfactant and have the ability to keep overall surfactant levels very low. This is advantageous since residual surfactant in the final toner can be problematic, especially in affecting the charging properties of the toner, particularly at high humidity. In addition, such processes avoid the need for large quantities of salt, as required for some prior art processes, which would need to be washed out.

Stirring and mixing are preferably performed during the association step.

The association step is preferably carried out below the Tg of the resin in the resin.

After the association step, the process preferably comprises a further step of heating and/or stirring the associated mixture (preferably at a temperature below the Tg of the resin particles). Preferably such heating and/or stirring of the associated mixture causes loose (uncoalesced or unfused) aggregates to form. The aggregates are composite particles comprising the primary particles of resin, colorant and optionally wax. Preferably, the aggregates are of particle size from 1 to 20 μm, more preferably from 2 to 20 μm. Once the desired aggregate particle size is established, the aggregates may be stabilised against further growth. This may be achieved, for example, by addition of further surfactant, and/or by a change in pH where a pH switch process was employed for the association as is known in the art (e.g. WO 98/50828). The aggregates may be recovered by methods known in the art and may be usable as toner particles as they are or, preferably, the aggregates may be subjected to further treatment as described below to improve their suitability as toner particles.

After the association step and optional further step of heating and/or stirring to establish the desired aggregate particle size, the temperature may then be raised above the T_{g} of the resin in a fusion step to form toner particles. The fusion step brings about fusion (i.e. coalescence) of the aggregates. The fusion may occur by fusion of the primary particles within each aggregate and/or between aggregates, to form toner particles. The aggregates and/or toner particles typically have a volume average particle size from 2 to 20 μm, more preferably 4 to 10 μm, still more preferably 5 to 9 μm and most preferably 6 to 8 μm. During this fusion step of heating above the T_{g} the shape of the toner may be controlled through selection of the temperature and the heating time.

In certain embodiments, the fusion of the aggregates may be effected at the same time as formation of the aggregates, although it is more preferred to use the method described above of performing the fusion step after formation of the aggregates.

The dispersion of toner particles may then be cooled and the toner particles recovered, e.g. by filtration, for subsequent use as an electrophotographic toner. The toner may then optionally be washed (e.g. to remove at least some surfactant) and/or optionally be dried using methods known in the art. The washing step, for example, may comprise washing with water, or dilute acid or base. Drying, for example, may comprise drying assisted by heat and/or reduced pressure (vacuum).

The toner particles, especially the recovered and dried toner particles, may be blended with one or more surface additives to improve the powder flow properties of the toner, or to tune the tribocharge or other properties, as is known in the art. Typical surface additives include, but are not limited to inorganic oxides, carbides, nitrides and titanates. Inorganic oxides include silica and metal oxides such as titania and alumina. Organic additives include polymeric beads (for example acrylic or fluoropolymer beads) and metal stearates (for example zinc stearate). Conducting additive particles may also be used, including those based on tin oxide (e.g. those containing antimony tin oxide or indium tin oxide). Silica, titania and alumina are preferred. Silica is most preferred.

Each surface additive may be used at 0.1-5.0 wt % based on the weight of the unblended toner (i.e. the toner prior to addition of the surface additive), preferably 0.2-3.0 wt %, more preferably 0.25-2.0 wt %. The total level of surface additives used may be from about 0.1 to about 10 wt %, preferably from about 0.5 to 5%, based on the weight of the unblended toner. Preferably, the surface additives comprise silica in an amount 0.5 to 5%

The additives may be added by blending with the toner, using, for example, a Henschel blender, a Nara Hybridiser, or a Cyclomix blender (available from Hosokawa).

The particles of the above surface additives, including silica, titania and to alumina, preferably may be made hydrophobic, e.g. by reaction with a silane and/or a silicone polymer. Examples of hydrophobising groups include alkyl halosilanes, aryl halosilanes, alkyl alkoxysilanes (e.g. butyl trimethoxysilane, iso-butyl trimethoxysilane and octyl trimethoxysilane), aryl alkoxysilanes, hexamethyldisilazane, dimethylpolysiloxane and octamethylcyclotetrasiloxane. Other hydrophobising groups include those containing amine or ammonium groups. Mixtures of hydrophobising groups can be used (for example mixtures of silicone and silane groups, or alkylsilanes and aminoalkylsilanes.)

Examples of hydrophobic silicas include those commercially available from Nippon Aerosil, Degussa, Wacker-Chemie and Cabot Corporation. Specific examples include those made by reaction with dimethyldichlorosilane (e.g. Aerosil™ R972, R974 and R976 from Degussa); those made by reaction with dimethylpolysiloxane (e.g. Aerosil™ RY50, NY50, RY200, RY200S and R202 from Degussa); those made by reaction with hexamethyldisilazane (e.g. Aerosil™ RX50, NAX50, RX200, RX300, R812 and R812S from Degussa); those made by reaction with alkylsilanes (e.g. Aerosil™ R805 and R816 from Degussa) and those made by reaction with octamethylcyclotetrasiloxane (e.g. Aerosil™ R104 and R106 from Degussa).

The primary particle size of suitable surface additives, especially silicas, is typically from 5 to 200 nm, preferably from 7 to 50 nm. The BET surface area of the additives, especially silicas, may be from 10 to 350 m²/g, preferably 30-300 m²/g. Combinations of additives, especially silicas, with different particle size and/or surface area may be used.

It is possible to blend the different size additives in a single blending step, but it is often preferred to blend them in separate blending steps. In this case, the larger additive may be blended before or after the smaller additive. It may further be preferred to use two stages of blending, where in at least one stage a mixture of additives of different particle size is used. For example, an additive with low particle size may be used in the first stage, with a mixture of additives of different particle size in the second step.

Where titania is used, it is preferred to use a grade which has been hydrophobised, e.g. by reaction with an alkylsilane and/or a silicone polymer. The titania may be crystalline or amorphous. Where crystalline it may consist of rutile or anatase structures, or mixtures of the two. Examples include grades T805 or NKT90 from Nippon Aerosil and STT-30A from Titan Kogyo.

Hydrophilic or hydrophobic grades of alumina may be used. An example is Aluminium Oxide C from Degussa.

It is often preferred to use combinations of silica and titania, or of silica, titania and alumina. Combinations of large and small silicas, as described above, can be used in conjunction with titania, alumina, or with blends of titania and alumina. It is also often preferred to use silica alone. In that case, combinations of large and small silicas, as described above, can be used.

Preferred formulations of surface additives include those in the following list:
hydrophobised silica;
large and small particle size silica combinations, which silicas may be optionally hydrophobised;
hydrophobised silica and one or both of hydrophobised titania and hydrophilic or hydrophobised alumina;
large and small particle size silica combinations as described above; and
one or both of hydrophobised titania and hydrophilic or hydrophobised alumina.

Polymer beads or zinc stearate may be used to improve the transfer efficiency or cleaning efficiency of the toners. Charge control agents (CCAs) may be added in the external formulation (i.e. surface additive formulation) to modify the charge level or charging rate of the toners.

The process according to the present invention is especially suitable for producing a toner of narrow particle size distribution.

Preferably, the toner obtainable by the process of the present invention has a volume average particle size in the range from 2 to 20 μm and the GSDₙ value is not greater than 1.30.

The GSDₙ value is defined by the following expression:

GSDₙ=D₅₀/D_{15.9}

wherein D₅₀ is the particle size below which 50% by number of the toner particles have their size and D_{15.9} is the particle size below which 15.9% by number of the toner particles have their size.

Preferably, the GSDₙ value is not greater than 1.28 and more preferably not greater than 1.25. Of course, mathematically GSDₙ can be no less than 1.0.

A GSDᵥ value is defined by the following expression:

GSDᵥ=D_{84.1}/D₅₀

wherein D_{84.1} is the particle size below which 84.1% by volume of the toner particles have their size and D₅₀ is the particle size below which 50% by volume of the toner particles have their size.

Preferably the GSDᵥ value is not greater than 1.30, more preferably not to greater than 1.25, still more preferably not greater than 1.23. Of course, mathematically GSDᵥ can be no less than 1.0.

The volume average particle size of the toner is preferably in the range from 4 to 10 μm, more preferably 5 to 9 μm, and most preferably in the range from 6 to 8 μm.

The volume average particle size and the particle size distribution (GSDₙ and GSDᵥ) refer to sizes as measured using a Coulter™ counter with a 100 μm aperture. For example, a Coulter™ Multisizer III instrument may be used. The Coulter™ counter measurement may be conveniently obtained in the present invention by analysing the dispersion of toner particles produced, e.g. after the fusion step of the process.

The low GSDₙ and GSDᵥ of the toner according to the present invention provides, among other things, that the toner may possess a more uniform charge distribution leading to improved image quality and higher resolution and have a lower tendency toward filming.

The toner according to the present invention preferably has a mean circularity, as hereinafter defined, of the toner particles as measured by a Flow Particle Image Analyser of at least 0.90, more preferably of at least 0.93.

The circularity measured by use of a Flow Particle Image Analyser (Sysmex FPIA) is defined as the ratio:

Lo/L

where Lo is the circumference of a circle of equivalent area to the particle, and L is the perimeter of the particle itself.

Further preferably, the shape factor of the toner particles, SF1, as hereinafter defined, is at most 165, more preferably at most 155.

Additionally preferably, the shape factor of the toner particles, SF2, as hereinafter defined, is at most 155, more preferably at most 145.

The shape factors SF1 and SF2 of the toner may be measured by image analysis of images generated by scanning electron microscopy (SEM).

The shape factor, SF1, is defined as:

SF1=(ML)²/A×π/4×100, where ML=maximum length across toner, A=projected area

The shape factor, SF2, is defined as:

SF2=P²/A×1/4π×100, where P=the perimeter of the toner particle, A=projected area

An average of approximately 100 particles is taken to define the shape factors (SF1 and SF2) for the toner.

The smoothness of the toner after the coalescence stage may also be assessed by measuring the surface area of the toner, for example by the BET method. It is preferred that the BET surface area of the unblended toner is in the range 0.5-1.5 m²/g.

Toner having the above shape properties has been found to have high transfer efficiency from the photoconductor to a substrate (or to an intermediate transfer belt or roller), in some cases close to 100% transfer efficiency.

If the toner is designed for a printer or copier which does not employ a mechanical cleaning device, it may be preferred to fuse (coalesce) the toner in the fusion step until a substantially spherical shape is attained, e.g. wherein the mean circularity is at least 0.98. If, however, the toner is designed for use in a printer or copier in which a mechanical cleaning device is employed to remove residual toner from the photoconductor after image transfer, it may be preferred to select a smooth but off-spherical shape, where the mean circularity is in the range 0.90-0.99, preferably 0.93-0.98, more preferably 0.94-0.98 and still more preferably 0.94-0.96. In the smooth but off-spherical shape, SF1 is particularly preferably 120-150 and SF2 is particularly preferably 110-145.

Where a wax is used in the process to obtain the toner, the wax is preferably present in the obtained toner in domains of mean diameter 2 μm or less, preferably 1.5 μm or less. Preferably, the wax domains are of mean diameter 0.5 μm or greater. If the mean size of the wax domains is >2 μm, the transparency of the printed film may be reduced, and the storage stability may decrease. The domain size values are preferably those measured by analysing sections of the toner by transmission electron microscopy. Preferably the wax is not substantially present at the surface of the toner.

The toner may be used as a mono-component or a dual component developer. In the latter case the toner is mixed with a suitable carrier bead.

Advantageously, the toner may be capable of fixing to the substrate at low temperatures by means of heated fusion rollers where no release oil is applied and may be capable of releasing from the fusion rollers over a wide range of fusion temperatures and speeds, and over a wide range of toner print densities. Furthermore, preferably, the toner according to the invention does not lead to background development of the photoconductor (e.g. OPC) and preferably does not lead to filming of the metering blade or development roller (for a mono-component device) or the carrier bead (for a dual-component device), or of the photoconductor.

Preferably, the haze values of prints using the toner of the invention do not vary considerably with fusion temperature. Haze may be assessed using a spectrophotometer, for example a Minolta CM-3600d, following ASTM D 1003. Preferably, the haze at a print density of 1.0 mg/cm² is below 40, preferably below 30, and the ratio of the values at fusion temperatures of 130 and 160° C. is preferably at most 1.5, more preferably 1.3 and most preferably 1.2.

The process can produce a toner which may be capable of one or more of the following: fixing to a substrate at low temperatures by means of heated fusion rollers; releasing from the fusion rollers over a wide range of fusion temperatures and speeds, and over a wide range of toner print densities; possessing good storage stability, print transparency, toner charging characteristics and does not lead to background development of the photoconductor; not leading to filming of the metering blade or development roller (for a mono-component device) or the carrier bead (for a dual-component device), or of the photoconductor; having high transfer efficiency from the photoconductor to the substrate or intermediate transfer belt or roller and from the transfer belt or roller (where used) to the substrate; enabling efficient cleaning of any residual toner remaining after image transfer where a mechanical cleaning device is used.

The toner of the invention may be particularly suitable for use in an electroreprographic apparatus or method where one or more of the following hardware conditions of an electroreprographic device applies:
i) where the device contains a developer roller and metering blade (i.e. where the toner is a monocomponent toner);
ii) where the device contains a cleaning device for mechanically removing waste toner from the photoconductor;
iii) where the photoconductor is charged by a contact charging means;
iv) where contact development takes place or a contact development member is present;
v) where oil-less fusion rollers are used;
vi) where the above devices are four colour printers or copiers, including tandem machines

Preferably, the invention provides a toner which satisfies many requirements simultaneously. The toner may be particularly advantageous for use in a mono-component electroreprographic apparatus and may be capable of demonstrating: formation of high resolution images; release from oil-less fusion rollers over a wide range of fusion temperature and print density; high transparency for OHP slides over a wide range of fusion temperature and print density; high transfer efficiency and the ability to clean any residual toner from the photoconductor, and exhibiting little or no filming of the metering blade, development roller and photoconductor over a long print run.

Throughout the description and claims of this specification, the words “comprise” and “contain” and variations of the words, for example “comprising” and “comprises”, mean “including but not limited to”, and are not intended to (and do not) exclude other components and/or steps.

Unless the context clearly indicates otherwise, plural forms of the terms herein are to be construed as including the singular form and vice versa.

Any steps in a process described herein may be performed in any order, is unless stated otherwise or unless the context clearly requires otherwise.

Unless stated otherwise, all amounts specified in % by weight are based on the weight of the total solids content of the mixed dispersion.

It will be appreciated that some of the compounds forming part of the present invention may exist in more than one tautomeric form. Accordingly, for the avoidance of doubt, the invention encompasses all tautomers of the compounds and not just any particular tautomers that may be shown in Formulae.

It will be appreciated that some of the compounds forming part of the present invention may exist in more than one isomeric and/or isotopic form. Accordingly, for the avoidance of doubt, the invention encompasses all isomers and/or isotopes of the compounds and not just any particular isomers and/or isotopes that may be shown in Formulae.

It will be appreciated that variations to the foregoing embodiments of the invention can be made while still falling within the scope of the invention. Each feature disclosed in this specification, unless stated otherwise, may be replaced by alternative features serving the same, equivalent or similar purpose. Thus, unless stated otherwise, each feature disclosed is one example only of a generic series of equivalent or similar features.

All of the features disclosed in this specification may be combined in any combination, except combinations where at least some of such features and/or steps are mutually exclusive. In particular, the preferred features of the invention are applicable to all aspects of the invention and may be used in any combination. Likewise, features described in non-essential combinations may be used separately (not in combination).

It will be appreciated that many of the features described above, particularly of the preferred embodiments, are inventive in their own right and not just as part of an embodiment of the present invention. Independent protection may be sought for these features in addition to or alternative to any invention presently claimed.

Any discussion of documents, acts, materials, devices, articles and the like included herein is solely for the purpose of providing a context for the present invention. It is not suggested or represented that any or all of these matters formed part of the prior art or were common general knowledge in the field relevant to the present invention as it existed before the priority date or filing date of this patent application.

The invention will now be illustrated by the following Examples, which are non-limiting on the scope of the invention. All percentages or parts referred to are percentages or parts by weight unless otherwise stated. The solids content quoted for the dispersions in these examples includes any surfactant present in the dispersion.

### EXAMPLES

### 1. Preparation of Latexes (Resin Dispersions)

1.1. Synthesis of Low Molecular-Weight Latex (a-1)

A low molecular weight resin was synthesised by emulsion polymerisation. The monomers used were styrene (82.5 wt %), 2-hydroxyethyl methacrylate (2.5 wt %) and acrylic ester monomers (15.0 wt %). Ammonium persulphate (0.5 wt % on monomers) was used as the initiator and a mixture of thiol chain transfer agents (2.5 wt %) were used as chain transfer agents. The surfactant was Akypo™ RLM100 available from Kao. The amount of Akypo™ RLM 100 used for the polymerisation was 3 wt % based on the weight of the monomers (2.83 wt % based on the total solids content of the latex). Akypo™ RML 100 is an anionic surfactant (a carboxylated alkyl ethoxylate, i.e. a carboxy-functional surfactant), which has a Formula A above and a linear chain length in the range 40 to 50. The emulsion had a particle size of 93 nm, and a Tg midpoint (as measured by differential scanning calorimetry (DSC) of 64.3° C. Gel permeation chromatography (GPC) analysis against polystyrene standards showed the resin to have Mn=4,600, Mw=21,700, Mw/Mn=4.7. The total solids content was 30 wt %.

1.2. Synthesis of Low Molecular-Weight Latex (a-2)

A low molecular weight resin was synthesised by emulsion polymerisation. The monomers used were styrene (82.5 wt %), 2-hydroxyethyl methacrylate (2.5 wt %) and acrylic ester monomers (15.0 wt %). Ammonium persulphate (0.5 wt % on monomers) was used as the initiator, and a mixture of thiol chain transfer agents (2.5 wt %) was used as chain transfer agents. The surfactant was Akypo™ RLM100 (available from Kao, 3 wt % on monomers). The emulsion had a particle size of 93 nm, and a Tg midpoint as measured by DSC of 64.0° C. GPC analysis against polystyrene standards showed the resin to have Mn=7,600, Mw=21,300, Mw/Mn=2.8. The solids content was 30 wt %.

1.3 Synthesis of Medium Molecular-Weight Latex (a-3)

A bimodal molecular weight distribution resin was made by a two-stage polymerisation process, in which the higher molecular weight portion was made in the absence of chain transfer agent, and in which the molecular weight of the lower molecular weight portion was reduced by use of 2.5 wt % of mixed thiol chain transfer agents. Ammonium persulphate (0.5 wt % on monomers) was used as the initiator and the surfactant was Akypo™ RLM100 used at 3.0 wt % based on is monomers (2.88 wt % based on the total solids content of the latex). The monomer composition of the low molecular weight portion was styrene (82.5%), 2-hydroxyethyl methacrylate (2.5 wt %) and acrylic ester monomers (15.0 wt %). The overall monomer composition was styrene (73.85 wt %), 2-hydroxyethyl methacrylate (6.25 wt %) and acrylic ester monomers (19.9 wt %). The emulsion had a particle size of 88 nm and a Tg midpoint as measured by DSC of 64.1° C. GPC analysis against polystyrene standards showed the resin to have Mn=10,800, Mw=244,700, Mw/Mn=22.7. The solids content was 40 wt %.

1.4 Synthesis of Medium Molecular-Weight Latex (a-4)

A bimodal molecular weight distribution latex was made by a two-stage polymerisation process, in which the higher molecular weight portion was made in the absence of chain transfer agent, and in which the molecular weight of the lower molecular weight portion was reduced by use of 2.5 wt % of mixed thiol chain transfer agents. Ammonium persulphate (0.5 wt % on monomers) was used as the initiator, and the surfactant was Akypo™ RLM100 (available from Kao, 3.0 wt % on monomers). The monomer composition of the low molecular weight portion was styrene (82.5%), 2-hydroxyethyl methacrylate (2.5 wt %) and acrylic ester monomers (15.0 wt %). The overall monomer composition was styrene (73.85 wt %), 2-hydroxyethyl methacrylate (6.25 wt %) and acrylic ester monomers (19.9 wt %). The emulsion had a particle size of 80 nm and a Tg midpoint as measured by DSC of 65.8° C. GPC analysis against polystyrene standards showed the resin to have Mn=15,800, Mw=167,600, Mw/Mn=10.6. The solids content was 40 wt %.

### 2. Pigment Dispersions

2.1 Cyan Pigment Dispersion (b-1) (with CCA)

A dispersion of CI Pigment Blue 15:3 was used. The pigment (75 wt pts) was milled in water using a bead mill, along with a charge control agent (CCA), BONTRON™ E88 (ex Orient) (25 wt pts), Akypo™ RLM100 (10 wt pts) and Solsperse™ 27,000 (10 wt pts) as surfactants. Solsperse™ 27,000 is a non-ionic surfactant available from Noveon. The total solids content of the dispersion, including surfactant, was 30.37% by weight. Individually, the pigment content of the dispersion was 18.98% by weight and the CCA content of the dispersion was 6.33% by weight.

2.2 Cyan Pigment Dispersion (b-2) (with CCA)

A dispersion of CI Pigment Blue 15:3 and BONTRON™ E88 was prepared in exactly the same way as described in 2.1. The resulting dispersion was identical to that prepared in 2.1 with exception that the final solids content was 31.15% by weight.

2.3 Cyan Pigment Dispersion (b-3)(no CCA)

A dispersion of CI Pigment Blue 15:3 was used. The pigment (100 wt pts) was milled in water using a bead mill, along with Akypo™ RLM100 (12 wt pts) and Solsperse™ 27,000 (10 wt pts) as surfactants. The total solids content of the dispersion, including surfactant, was 28.37% by weight.

### 3. Wax Dispersions

3.1 Wax Dispersion (c-1)

A wax mixture comprising 80 parts by weight Paraflint™ C80 (a Fischer-Tropsch wax) and 20 parts by weight carnauba wax was melt dispersed in water, with Akypo™ RLM100 (Kao) as surfactant. The Akypo surfactant was used in an amount 20% by wt based on the total solid content (wax and surfactant) of the dispersion. The total solids content of the dispersion was 25.3% by weight.

3.2 Wax Dispersion (c-2)

A wax dispersion was prepared in exactly the same way as described in 3.1. The final product was identical to that produced in 3.1 with the exception that the final solids content was 25.85% by weight.

### 4. Wet-Cakes CCA

4.1 Wet-Cake CCA (d-1)

A wet-cake of CCA comprising BONTRON™ E88 (ex Orient) in water was used. The total solids of the wet-cake was 22.1% by weight. BONTRON™ E88 is an aluminium complex of an alkyl salicylic acid compound (i.e. a carboxy functional compound of Formula (1) in complex form).

4.2 Wet-Cake CCA (d-2)

A wet-cake of CCA was prepared in exactly the same manner as 4.1. The final wet cake was identical to that prepared in 4.1 except that the solids content was 23.28% by weight.

### 5. Toner Preparation

### 5.1 Comparative Example 1

### No Second Ionic Surfactant

Latex (a-1) (947.55 g), Latex (a-3) (258.42 g), the pigment dispersion (b-1) (104.31 g), wax dispersion (c-1) (104.82 g), wet-cake CCA (d-1) (11.40 g) and water (1300.5 g) were mixed and stirred in a vessel.

The total amount of Akypo™ RLM 100 anionic surfactant in the mixed dispersion formed was 4.2% wt based on the solids content of the mixed dispersion (i.e. based on the weight of the surfactants, resin, pigment, wax and CCA).

The temperature of the mixture was raised to 30° C. The mixture was circulated through a high shear mixer and back into the vessel, during which 2% sulphuric acid (450 g) was added into the high shear mixer over 4 minutes. The pH had reduced from about 7 initially to 1.86 after addition of the acid to cause association of the particles. The mixture was heated for the next 170 minutes (to a maximum temperature of 61° C.) to allow for the formation of toner sized aggregates. The mixture was then cooled to 35° C. A solution of sodium hydroxide 0.5 M (257.5 g) was added over 20 minutes to raise the pH to 7 to inhibit a further increase in particle size. The temperature of the mixture was then raised to 131° C. in a pressurised vessel to fuse the toner sized particles and held at this temperature for a total of 120 minutes with stirring before being cooled to a temperature of 25° C. Particle size measurement using a Coulter Counter™ instrument showed the mean volume particle size of the resultant toner particles was 6.39 μm, the GSDv was 1.22 and the GSDn was 1.30. When magnified under an optical microscope the toner particles were seen to be of uniform size and slightly irregular in shape.

### 5.2 Comparative Example 2

### No Second Ionic Surfactant

Latex (a-1) (947.55 g), Latex (a-3) (258.42 g), the pigment dispersion (b-1) (81.36 g), wax dispersion (c-1) (102.59 g), wet-cake CCA (d-1) (10.82 g) and water (1549.25 g) were mixed and stirred in a vessel.

The temperature of the mixture was raised to 30° C. The mixture was circulated through a high shear mixer and back into the vessel, during which 2% sulphuric acid (450 g) was added into the high shear mixer over 4 minutes. The pH had reduced from about 7 initially to 2.0 after addition of the acid to cause association of the particles. The mixture was heated for the next 174 minutes (to a maximum temperature of 60.7° C.) to allow for the formation of toner sized aggregates. The mixture was then cooled to 35° C. A solution of sodium hydroxide 0.5 M (262.5 g) was added over 20 minutes to raise the pH to 7 to inhibit a further increase in particle size. The temperature of the mixture was then raised to 131° C. in a pressurised vessel to fuse the toner sized particles and held at this temperature for a total of 120 minutes with stirring before being cooled to a temperature of 25° C. Particle size measurement using a Coulter Counter™ instrument showed the mean volume particle size of the resultant toner particles was 6.94 μm, the GSDv was 1.23 and the GSDn was 1.31. When magnified under an optical microscope the toner particles were seen to be of uniform size and slightly irregular in shape.

### 5.3 Comparative Example 3

### No Second Ionic Surfactant

Latex (a-2) (1093.33 g), Latex (a-4) (298.18 g), the pigment dispersion (b-2) (93.88 g), wax dispersion (c-2) (118.38 g), wet-cake CCA (d-1) (13.15 g) and water (1235.44 g) were mixed and stirred in a vessel.

In a separate bottle 2-hydroxy-3-naphthoic acid (a compound of Formula I also known as “bon acid”) (7.65 g) was dissolved in 78.35 g of sodium hydroxide (0.5 M). The resultant solution was then added to the latex, pigment, wax, CCA mixture.

The temperature of the mixture was raised to 30° C. The mixture was circulated through a high shear mixer and back into the vessel, during which 2% sulphuric acid (460 g) was added into the high shear mixer over 4 minutes. The pH had reduced from about 7 initially to 2.67 after addition of the acid to cause association of the particles. The mixture was heated for the next 174 minutes (to a maximum temperature of 61.5° C.) to allow for the formation of toner sized aggregates. The mixture was then cooled to 35° C. A solution of sodium hydroxide 0.5 M (237.4 g) was added over 12 minutes to raise the pH to 7 to inhibit a further increase in particle size. The temperature of the mixture was then raised to 131° C. in a pressurised vessel to fuse the toner sized particles and held at this temperature for a total of 120 minutes with stirring before being cooled to a temperature of 25° C. Particle size measurement using a Coulter Counter™ instrument showed the mean volume particle size of the resultant toner particles was 7.36 μm, the GSDv was 1.21 and the GSDn was 1.29. When magnified under an optical microscope the toner particles were seen to be of uniform size and slightly irregular in shape.

### 5.4 Comparative Example 4

### No Second Ionic Surfactant and No Compound of Formula 1

Latex (a-1) (969.50 g), Latex (a-3) (264.32 g), the pigment dispersion (b-3) (91.32 g), wax dispersion (c-1) (104.82 g) and water (1300.48 g) were mixed and stirred in a vessel.

The temperature of the mixture was raised to 30° C. The mixture was circulated through a high shear mixer and back into the vessel, during which 2% sulphuric acid (450 g) was added into the high shear mixer over 4 minutes. The pH had reduced from about 7 initially to 1.85 after addition of the acid to cause association of the particles. The mixture was heated for the next 174 minutes (to a maximum temperature of 61.3° C.) to allow for the formation of toner sized aggregates. The mixture was then cooled to 35° C. A solution of sodium hydroxide 0.5 M (265.1 g) was added over 20 minutes to raise the pH to 7 to inhibit a further increase in particle size. The temperature of the mixture was then raised to 131° C. in a pressurised vessel to fuse the toner sized particles and held at this temperature for a total of 120 minutes with stirring before being cooled to a temperature of 25° C. Particle size measurement using a Coulter Counter™ instrument showed the mean volume particle size of the resultant toner particles was 6.23 μm, the GSDv was 1.25 and the GSDn was 1.33. When magnified under an optical microscope the toner particles were seen to be of uniform size and slightly irregular in shape.

### 5.5 Example 1

### Containing Two Ionic Surfactants and Bon Acid

Latex (a-1) (1093.3 g), Latex (a-3) (298.2 g), the pigment dispersion (b-1) (120.4 g), wax dispersion (c-1) (120.9 g), wet-cake CCA (d-1) (13.15 g) and water (1159.4 g) were mixed and stirred in a vessel.

In a separate bottle, 7.65 g of 2-hydroxy-3-naphthoic acid (“bon acid”) was dissolved in 86.03 g of sodium hydroxide (0.5 M). The resultant solution of the bon acid salt was then added to the latex, pigment, wax, CCA mixture prior to association.

In a separate bottle, a second anionic surfactant, Marlowet™ 4539 (available from Sasol), in a 90% solution (5.67 g) was dissolved in 35 g of sodium hydroxide (0.5 M). Marlowet™ 4539 is an anionic surfactant of Formula A as defined above with a linear chain length in the range 20 to 30. The resultant solution was then added to the latex, pigment, wax, CCA mixture prior to association.

The total amount of Akypo™ RLM 100 anionic surfactant in the mixed dispersion formed was 4.1% wt based on the solids content of the mixed dispersion (i.e. based on the weight of the surfactants, resin, pigment, wax and CCA). The total amount of Marlowet™ 4539 anionic surfactant in the mixed dispersion formed was 1.0% wt based on the solids content of the mixed dispersion. The amount of the bon acid was 1.4% wt based on the solids content of the mixed dispersion.

The temperature of the mixture was raised to 30° C. The mixture was circulated through a high shear mixer and back into the vessel, during which 2% sulphuric acid (460 g) was added into the high shear mixer over 4 minutes. The pH had reduced from about 8 initially to 2.43 after addition of the acid to cause association of the particles. The mixture was heated for the next 174 minutes (to a maximum temperature of 62° C.) to allow for the formation of toner sized aggregates. The mixture was then cooled to 35° C. A solution of sodium hydroxide 0.5 M (212.3 g) was added over 20 minutes to raise the pH to 7 to inhibit a further increase in particle size. The temperature of the mixture was then raised to 131° C. in a pressurised vessel to fuse the toner sized particles and held at this temperature for a total of 120 minutes with stirring before being cooled to a temperature of 25° C. Particle size measurement using a Coulter Counter™ instrument showed the mean volume particle size was 7.79 μm, the GSDv was 1.20 and the GSDn was 1.26. When magnified under an optical microscope the toner particles were seen to be of uniform size and slightly irregular in shape.

### 5.6 Example 2

### Containing Two Ionic Surfactants and Bon Acid

Latex (a-1) (1093.3 g), Latex (a-4) (298.18 g), the pigment dispersion (b-2) (94.61 g), wax dispersion (c-1) (120.95 g), wet-cake CCA (d-1) (13.15 g) and water (1142 g) were mixed and stirred in a vessel.

In a separate bottle, 5.43 g of 2-hydroxy-3-naphthoic acid (“bon acid”) was dissolved in 57 g of sodium hydroxide (0.5 M). The resultant solution of the bon acid salt was then added to the latex, pigment, wax, CCA mixture prior to association.

In a separate bottle, a second anionic surfactant, Marlowet™ 4539 (available from Sasol), in a 90% solution (8.5 g) was dissolved in 52.5 g of sodium hydroxide (0.5 M). The resultant solution was then added to the latex, pigment, wax, CCA mixture prior to association.

The temperature of the mixture was raised to 30° C. The mixture was circulated through a high shear mixer and back into the vessel, during which 2% sulphuric acid (460 g) was added into the high shear mixer over 4 minutes. The pH had reduced from about 8 initially to 2.78 after addition of the acid to cause association of the particles. The mixture was heated for the next 174 minutes (to a maximum temperature of 62° C.) to allow for the formation of toner sized aggregates. The mixture was then cooled to 35° C. A solution of sodium to hydroxide 0.5 M (234.3 g) was added over 20 minutes to raise the pH to 7 to inhibit a further increase in particle size. The temperature of the mixture was then raised to 131° C. in a pressurised vessel to fuse the toner sized particles and held at this temperature for a total of 120 minutes with stirring before being cooled to a temperature of 25° C. Particle size measurement using a Coulter Counter™ is instrument showed the mean volume particle size was 6.43 μm, the GSDv was 1.21 and the GSDn was 1.27. When magnified under an optical microscope the toner particles were seen to be of uniform size and slightly irregular in shape.

### 5.7 Example 3

### Containing Two Ionic Surfactants and Bon Acid

Latex (a-2) (1093.33 g), Latex (a-4) (298.18 g), the pigment dispersion (b-2) (93.88 g), wax dispersion (c-2) (118.38 g), wet-cake CCA (d-2) (12.49 g) and water (1182.7 g) were mixed and stirred in a vessel.

In a separate bottle, 5.10 g of 2-hydroxy-3-naphthoic acid (“bon acid”) was dissolved in 59 g of sodium hydroxide (0.5 M). The resultant solution of the bon acid salt was then added to the latex, pigment, wax, CCA mixture prior to association.

In a separate bottle, a second anionic surfactant, Marlowet™ 4539 (available from Sasol), in a 90% solution (17 g) was dissolved in 50 g of sodium hydroxide (0.5 M). The resultant solution was then added to the latex, pigment, wax, CCA mixture prior to association.

The temperature of the mixture was raised to 30° C. The mixture was circulated through a high shear mixer and back into the vessel, during which 2% sulphuric acid (470 g) was added into the high shear mixer over 4 minutes. The pH had reduced from about 8 initially to 2.78 after addition of the acid to cause association of the particles. The mixture was heated for the next 174 minutes (to a maximum temperature of 61.4° C.) to allow for the formation of toner sized aggregates. The mixture was then cooled to 35° C. A solution of sodium hydroxide 0.5 M (259.05 g) was added over 12 minutes to raise the pH to 7.09 to inhibit a further increase in particle size. The temperature of the mixture was then raised to 131° C. in a pressurised vessel to fuse the toner sized particles and held at this temperature for a total of 120 minutes with stirring before being cooled to a temperature of 25° C. Particle size measurement using a Coulter Counter™ instrument showed the mean volume particle size was 7.03 μm, the GSDv was 1.19 and the GSDn was 1.25. When magnified under an optical microscope the toner particles were seen to be of uniform size and slightly irregular in shape.

### 5.8 Example 4

### Containing Two Ionic Surfactants and Bon Acid

Latex (a-1) (1093.33 g), Latex (a-3) (298.2 g), the pigment dispersion (b-1) (120.36 g), wax dispersion (c-1) (120.97 g), wet-cake CCA (d-1) (13.16 g) and water to (1162 g) were mixed and stirred in a vessel.

In a separate bottle, 7.65 g of 2-hydroxy-3-naphthoic acid (“bon acid”) was dissolved in 86.33 g of sodium hydroxide (0.5 M). The resultant solution of the bon acid salt was then added to the latex, pigment, wax, CCA mixture prior to association.

In a separate bottle, a second anionic surfactant, Marlowet™ 4534 (available from Sasol), in a 90% solution (5.67 g) was dissolved in 35 g of sodium hydroxide (0.5 M). The resultant solution was then added to the latex, pigment, wax, CCA mixture prior to association.

The temperature of the mixture was raised to 30° C. The mixture was circulated through a high shear mixer and back into the vessel, during which 2% sulphuric acid (470 g) was added into the high shear mixer over 4 minutes. The pH had reduced from about 8 initially to 2.75 after addition of the acid to cause association of the particles. The mixture was heated for the next 174 minutes (to a maximum temperature of 62° C.) to allow for the formation of toner sized aggregates. The mixture was then cooled to 35° C. A solution of sodium hydroxide 0.5 M (232.89 g) was added over 20 minutes to raise the pH to 7 to inhibit a further increase in particle size. The temperature of the mixture was then raised to 131° C. in a pressurised vessel to fuse the toner sized particles and held at this temperature for a total of 120 minutes with stirring before being cooled to a temperature of 25° C. Particle size measurement using a Coulter Counter™ instrument showed the mean volume particle size was 7.53 μm, the GSDv was 1.19 and the GSDn was 1.26. When magnified under an optical microscope the toner particles were seen to be of uniform size and slightly irregular in shape.

### 5.9 Example 5

### Containing Two Ionic Surfactants and Bon Acid

Latex (a-1) (1093.33 g), Latex (a-4) (298.18 g), the pigment dispersion (b-2) (94.61 g), wax dispersion (c-1) (120.95 g), wet-cake CCA (d-1) (13.15 g) and water (1142 g) were mixed and stirred in a vessel.

In a separate bottle, 5.1 g of 2-hydroxy-3-naphthoic acid (“bon acid”) was dissolved in 57 g of sodium hydroxide (0.5 M). The resultant solution of the bon acid salt was then added to the latex, pigment, wax, CCA mixture prior to association.

In a separate bottle, a second anionic surfactant, Marlowet™ 4534 (available from Sasol), in a 90% solution (8.50 g) was dissolved in 52.5 g of sodium hydroxide (0.5 M). The resultant solution was then added to the latex, pigment, wax, CCA mixture prior to association.

The temperature of the mixture was raised to 30° C. The mixture was circulated through a high shear mixer and back into the vessel, during which 2% sulphuric acid (460 g) was added into the high shear mixer over 4 minutes. The pH had reduced from about 8 initially to 2.60 after addition of the acid to cause association of the particles. The mixture was heated for the next 174 minutes (to a maximum temperature of 62° C.) to allow for the formation of toner sized aggregates. The mixture was then cooled to 35° C. A solution of sodium hydroxide 0.5 M (241.2 g) was added over 14 minutes to raise the pH to 7 to inhibit a further increase in particle size. The temperature of the mixture was then raised to 131° C. in a pressurised vessel to fuse the toner sized particles and held at this temperature for a total of 120 minutes with stirring before being cooled to a temperature of 25° C. Particle size measurement using a Coulter Counter™ instrument showed the mean volume particle size was 6.67 μm, the GSDv was 1.21 and the GSDn was 1.28. When magnified under an optical microscope the toner particles were seen to be of uniform size and slightly irregular in shape.

### 5.10 Example 6

### Containing Two Ionic Surfactants and Bon Acid

Latex (a-2) (1093.33 g), Latex (a-4) (298.18 g), the pigment dispersion (b-2) (93.88 g), wax dispersion (c-2) (118.38 g), wet-cake CCA (d-2) (12.49 g) and water (1182.7 g) were mixed and stirred in a vessel.

In a separate bottle, 5.1 g of 2-hydroxy-3-naphthoic acid (“bon acid”) was dissolved in 59 g of sodium hydroxide (0.5 M). The resultant solution of the bon acid salt was then added to the latex, pigment, wax, CCA mixture prior to association.

In a separate bottle, a second anionic surfactant, Marlowet™ 4534 (available from Sasol), in a 90% solution (17 g) was dissolved in 50 g of sodium hydroxide (0.5 M). The resultant solution was then added to the latex, pigment, wax, CCA mixture prior to association.

The temperature of the mixture was raised to 30° C. The mixture was circulated through a high shear mixer and back into the vessel, during which 2% sulphuric acid (470 g) was added into the high shear mixer over 4 minutes. The pH had reduced from about 8 initially to 2.80 after addition of the acid to cause association of the particles. The mixture was heated for the next 174 minutes (to a maximum temperature of 61.3° C.) to allow for the formation of toner sized aggregates. The mixture was then cooled to 35° C. A solution of sodium hydroxide 0.5 M (258.3 g) was added over 12 minutes to raise the pH to 7 to inhibit a further increase in particle size. The temperature of the mixture was then raised to 131° C. in a pressurised vessel to fuse the toner sized particles and held at this temperature for a total of 120 minutes with stirring before being cooled to a temperature of 25° C. Particle size measurement using a Coulter Counter™ instrument showed the mean volume particle size was 6.51 μm, the GSDv was 1.19 and the GSDn was 1.25. When magnified under an optical microscope the toner particles were seen to be of uniform size and slightly irregular in shape.

### 5.11 Example 7

### Containing Two Ionic Surfactants and Bon Acid

Latex (a-1) (1093.40 g), Latex (a-3) (298.2 g), the pigment dispersion (b-1) (120.36 g), wax dispersion (c-1) (120.98 g), wet-cake CCA (d-1) (13.15 g) and water (1162 g) were mixed and stirred in a vessel.

In a separate bottle, 7.65 g of 2-hydroxy-3-naphthoic acid (“bon acid”) was dissolved in 86.33 g of sodium hydroxide (0.5 M). The resultant solution of the bon acid salt was then added to the latex, pigment, wax, CCA mixture prior to association.

In a separate bottle, a second anionic surfactant, Marlowet™ 4538 (available from Sasol), in a 90% solution (5.67 g) was dissolved in 32.38 g of sodium hydroxide (0.5 M). The resultant solution was then added to the latex, pigment, wax, CCA mixture prior to association.

The temperature of the mixture was raised to 30° C. The mixture was circulated through a high shear mixer and back into the vessel, during which 2% sulphuric acid (460 g) was added into the high shear mixer over 4 minutes. The pH had reduced from about 8 initially to 2.82 after addition of the acid to cause association of the particles. The mixture was heated for the next 174 minutes (to a maximum temperature of 62° C.) to allow for the formation of toner sized aggregates. The mixture was then cooled to 35° C. A solution of sodium hydroxide 0.5 M (227.4 g) was added over 20 minutes to raise the pH to 7 to inhibit a further increase in particle size. The temperature of the mixture was then raised to 131° C. in a pressurised vessel to fuse the toner sized particles and held at this temperature for a total of 120 minutes with stirring before being cooled to a temperature of 25° C. Particle size measurement using a Coulter Counter™ instrument showed the mean volume particle size was 6.79 μm, the GSDv was 1.20 and the GSDn was 1.27. When magnified under an optical microscope the toner particles were seen to be of uniform size and slightly irregular in shape.

The toners made in the Examples 1 to 7 had markedly smaller GSDn and GSDv values than did the Comparative Examples 1 to 4. This corresponds to narrower particle size distribution for the toners made by the process of the present invention. A comparison is shown in below in Table 1.

TABLE 1

| | | Bon | | | | | |
|---|---|---|---|---|---|---|---|
| | E88 | acid | MW4539 | MW4534 | MW4538 | GSDv | GSDn |
| C. | | | | | | | |
| Ex | | | | | | | |
| 1 | Y | — | — | — | — | 1.22 | 1.30 |
| 2 | Y | — | — | — | — | 1.23 | 1.31 |
| 3 | Y | 1.5% | — | — | — | 1.21 | 1.29 |
| 4 | N | — | — | — | — | 1.25 | 1.33 |
| Ex | | | | | | | |
| 1 | Y | 1.5% | 1.0% | — | — | 1.20 | 1.26 |
| 2 | Y | 1.0% | 1.5% | — | — | 1.21 | 1.27 |
| 3 | Y | 1.0% | 3.0% | — | — | 1.19 | 1.25 |
| 4 | Y | 1.5% | — | 1.0% | — | 1.19 | 1.26 |
| 5 | Y | 1.0% | — | 1.5% | — | 1.21 | 1.28 |
| 6 | Y | 1.0% | — | 3.0% | — | 1.19 | 1.25 |
| 7 | Y | 1.5% | — | — | 1.0% | 1.20 | 1.27 |

In Table 1 the first column tabulates the references for the Comparative Examples (C.Ex) or Examples (Ex). The second column indicates if Bontron™ E88 was (Y) or was not (N) present. The third column to the sixth column tabulate how much “Bon acid”, Marlowet™ 4539, 4534 or 4538 was present. In each case “-” means the component was not present. The percentages are by weight relative to the total weight of the toner. The seventh and eighth columns tabulate the GSDv and GSDn values for the final toner. Lower values indicate advantageously sharper or narrower particle size distributions.

1.-49. (canceled)

50. A process for the manufacture of a toner comprising toner particles which comprise at least resin and colorant, the process comprising the steps of: providing a mixed dispersion of at least primary resin particles, primary colorant particles and a carboxy functional compound of Formula (1) and/or a salt thereof and/or a complex thereof in a liquid medium, 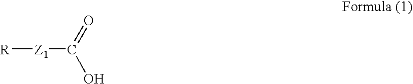
wherein R is a carbocyclic or heterocyclic group each of which may be optionally substituted,
Z₁ is a bond or a linker group, provided that when Z₁ is a linker group it spaces the carboxy group by no more than 3 atoms from R, and
the at least primary resin particles and primary colorant particles being stabilised by two or more surfactants in the liquid medium, the surfactants comprising at least a first ionic surfactant and a second ionic surfactant of the same polarity as the first ionic surfactant, wherein the first and second ionic surfactants have different linear chain lengths; and
causing the primary particles to associate.

51. A process according to claim 50 wherein the first ionic surfactant has a linear chain length of from 40 to 60.

52. A process according to claim 50 wherein the second ionic surfactant has a linear chain length of from 12 to 35.

53. A process according to claim 50 wherein the first and second ionic surfactants are reversibly ionisable ionic surfactants and the ionisation state of the first and second ionic surfactants can be reversibly changed by a change in pH of the liquid medium.

54. A process according to claim 50 wherein the first and second ionic surfactants have a carboxylate group.

55. A process according to claim 50 wherein the first and second ionic surfactants are alkyl or aryl alkoxylated carboxylates represented by Formula A:
R^{a}—O—(Z)ₘ—CH₂—CO₂⁻M⁺ Formula A
wherein:
R^{a} represents an optionally substituted alkyl or aryl group;
Z represents an alkylene oxide group;
m is an integer from 1 to 20; and
M⁺ represents a monovalent cationic counter-ion.

56. A process according to claim 50 wherein the first and second ionic surfactants are reversibly ionisable and the association of the primary particles is caused by effecting a change in the pH of the mixed dispersion to change the ionisation state of the first and second surfactants from a dispersion stabilising ionic form to a non-stabilising non-ionic form.

57. A process according to claim 50 wherein the total amount of carboxy functional compound and/or a salt and/or complex thereof is in the range 1 to 10% by weight based on the total solids content of the mixed dispersion.

58. A process according to claim 50 wherein R is optionally substituted phenyl or naphthyl.

59. A process according to claim 50 wherein the carboxy functional compound and/or salt thereof and/or complex thereof is a compound of the following Formula and/or a salt and/or a complex thereof:

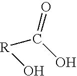

60. A process according to claim 50 wherein Z₁ is a bond.

61. A process according to claim 50 wherein the carboxy functional compound is a mixture of an optionally substituted salicylic acid and an optionally substituted hydroxy naphthoic acid, either or both of which are in the salt and/or complex form.

62. A toner obtainable by a process according to claim 50.

63. A toner according to claim 62 wherein the GSDₙ value is not greater than 1.28.

64. A two component developer comprising a toner according to claim 62 or claim 14 and a magnetic carrier.
